(19) United States
(12) Patent Application Publication
(10) Pub. No.: US 2019/0003871 A1
(43) Pub. Date: Jan. 3, 2019

(54) Pressure Sensor System

(71) Applicant: AUBREY DARE WESTMORELAND, III, Marshall, TX (US)

(72) Inventor: AUBREY DARE WESTMORELAND, III, Marshall, TX (US)

(21) Appl. No.: 15/636,685

(22) Filed: Jun. 29, 2017

(51) Int. Cl. G01F 23/284; G01F 23/70; G05D 9/12; F03B 15/06; G01P 5/14

(52) U.S. Cl. CPC G01F 23/284; G01F 23/706; G01P 5/14; F03B 15/06; G05D 9/12

(57) ABSTRACT

A pressure bladder comprising a substantially cylindrically shaped interior chamber is formed from a pliable, yet chemically resistant material, for example a fluoropolymer, such as FEP (fluorinated ethylene propylene). The interior chamber of the pressure bladder is hydraulically sealed at a distal end and is hydraulically coupled to a pressure sensor at a proximate end. Both the pressure bladder and pressure sensor are filled with an inert, non-reactive, stable measurement fluid. Optionally, a support mandrel with a second, smaller substantially cylindrically shaped interior chamber is hydraulically coupled between the pressure bladder and the pressure sensor and also filled with the measurement fluid. The pressure sensor is electrically coupled to electrical conductors, as is an optional thermistor. The conductors are received within a conductor protective tubing. The pressure sensor is disposed within a protective isolation tubing which is hydraulically coupled to the conductor protective tubing and to either the pressure bladder or support mandrel.

### BACKGROUND OF THE INVENTION

The present invention is related to tanks, pipes, conduits and system used for containing and transporting gases, liquids and multiphase hazardous materials properties, especially those having corrosive and reactive properties.

More particularly, the present invention is related to in situ measurement of the physical properties of the gasses, liquids and multiphase materials, especially those being designated as hazardous.

Recently, the Environmental Protection Agency and the Department of Transportation, as well as many state and local jurisdictions, have promulgated new rules regarding the proper handling, storage and transportation of many classes of hazardous materials (Hazardous Materials Regulations (HMR) USC 49 Parts 100-185), as well as designated new material as being hazardous. These new rules include new and upgraded designs for railcar tanks, trailer-tanks and mariner containers, heightened standards for terrestrial storage and processing tanks, as well as augmented rules for safe operation. While the bulk of the rule-making focuses on improved structural and mobility designs, others require new “safe-handling” and transportation procedures for the material as well as augmented monitoring, handling and transportation procedures especially for legacy structures that do not, or cannot conform to the new design regulations.

For the purposes of this discussion, hazardous materials include the following non-exhaustive list of hazardous categories: explosives; gases (flammable, nonflammable, nonpoisonous (nontoxic) compressed gas, poisonous (toxic) by inhalation; flammable liquids); flammable solids and reactive solids/liquids (flammable solid, spontaneously combustible material, dangerous when wet material); oxidizers and organic peroxides; poisonous (toxic) materials and infectious substances; radioactive materials; corrosive materials; and miscellaneous hazardous materials.

As mentioned above, the U.S. (as well as many state governments) have implemented new regulated designs essentially to provide further enhancements for containing hazardous materials, mitigating the spread of materials and limiting the exposure of the public in case of an accidental release, limiting the exposure of the public and monitoring the physical state of these materials.

As a practical matter, the benefits provided by many of these new regulations are offset, at least partially, by the reduction in risk and mitigation of exposure that the accidental release of these material may cause. The unchecked release of toxic, corrosive, radioactive, reactive or flammable materials into the environment can have a permanent effect on the environment, ecosystem and human habitation in the vicinity of the release.

With specific regard to liquids, gases and multi-phase (state) materials, many of these new regulations apply specifically to enhancing the structural design of containers, either static or transportation. New guidelines for construction practices, containment strength, materials section and reinforcing potential crumple zones enhance integral safety, while new operating procedures relate, at least partially, to safe storage and operating procedures, including enhanced material state monitoring procedures. This includes incorporating standards on materials in physical states that, heretofore, were considered safe and exempt from extensive monitoring, for example, extremely low pressure applications that scarcely differ from hydrostatic level.

Pressure sensors are well known in the prior art, such as deflection-type (see FIG. 1) and piezo-type (see FIG. 2). Deflection-type pressure sensors, such as exemplary deflection-type pressure sensor 100 depicted in FIG. 1, generally operate on the principle of deflecting a biased piston or diaphragm, that is, an external force, (p₁×a₁), created by medium 103 and exerted on a diaphragm will cause it to move a certain distance, or deflection, d₁. Exemplary deflection-type pressure sensor 100, as depicted as a cross-sectional view in the figure, is generally comprised of a case or housing 102 (shown as having a threaded fitting), a biased diaphragm 104, that is exposed to a first pressure to be measured, p₁, causing diaphragm 104 to move into measurement chamber 105 (using isolation seal 112). The linear distance or deflection, d₁, of biased diaphragm 104 into measurement chamber 105 is measured and converted to pressure. The amount of deflection, d₁, of diaphragm 104 is proportional to the pressure, p₁, exerted on the diaphragm. Measuring the deflection, d₁, of diaphragm 104 may be accomplished in various methods, such as by using a Hall Effect linear position sensor 108 to measure the linear position of magnet 106 that is affixed to diaphragm 104. Hall Effect linear position sensor 108 of deflection-type pressure sensor 100 will generally include a signal amplifier and connection pins 110 (optionally, protective cap 114 may cover case 102 and pins 110 and conductors) for electrically coupling the device. The description of deflection-type pressure sensor 100 is merely exemplary and may be modified a variety of ways, such as by using a biased piston instead of a diaphragm, or by using another type of linear position sensor.

Deflection-type pressure sensors have one interesting feature, as the area, a₁, of the piston exposed to the external pressure, p₁, is increased for the deflection piston/diaphragm, the force (p₁×a₁) on the biased diaphragm increases and therefore, assuming the biasing is constant, deflection, d₁, increases, thereby increasing the dynamic measurement range of the device. Hence, although deflection-type pressure sensors are generally regarded for application in mid- to high pressure applications, it is possible to configure these sensors for measuring fairly low pressures. Deflection-type pressure sensors are highly accurate and produced in quantity, fairly inexpensive, however, as they utilize multiple moving parts, are prone to wear and ultimately, failure. With the advent of piezoelectric, piezo-resistive and piezo-capacitive devices, piezoelectric elements have been employed in piezoelectric-type pressure sensors that accurately measure pressures without any (or very slight) movements.

Piezoelectric-type pressure sensors, such as exemplary piezoelectric-type pressure sensor 200 depicted in FIG. 2, operate on the principle that the electrical properties of a piezoelectric proportional are to the pressure exerted on them. An external force, p₁, within medium 103 and transmitted into a measurement chamber containing a piezoelectric element (or die) that results in a proportion change in the die that can be measured and converted to a pressure measurement. Exemplary piezoelectric-type pressure sensor 200, as depicted as a cross-sectional view in the figure, is generally comprised of a case or housing 202 (shown as having a barbed fitting), which forms measurement chamber 203, wherein piezoelectric die 206 is mounted on base 204. The element will produce a low voltage (in the millivolt range) proportional to the pressure that is amplified and then measured. Contacts 207 form an electrical bridge between piezoelectric die 206 and processing and signal amplifying electronics 208, which is further coupled to external pins 210. The piezoelectric element is rather durable and may be left directly exposed (referred to as “wet fitting”). The description of piezoelectric-type pressure sensor 200 is merely exemplary and may be modified a variety of ways, such as by “dry-fitting” the piezoelectric element between a sealant and fixed base, or forming the piezoelectric element on a diaphragm that deflect with pressure. Piezoelectric-type pressure sensor elements are abundant, extremely inexpensive, accurate and somewhat configurable, although the pressure sensor devices are less so. Even so, these types of pressure sensor devices have essentially taken over the sensor market.

While both deflection-type and piezoelectric-type pressure devices have been extremely successful, their acceptance has largely been limited to general use applications. Conversely, special-use pressure sensors are sometimes extraordinarily expensive. For example, proposed environmental rule changes will re-classify low- and no-pressure chemical tanks (see the chemical tank depicted in FIG. 11C) with other, more specialized tanks designed for holding hazardous chemicals (oxidizers, reactants, corrosives, etc.). These acrylic and poly chemical injection tanks are used extensively in remote oilfield locations, especially for conditioning hydrocarbons in pipelines from wellhead to pump station. Typically, crude gas contains many impurities that affect flow, including water, carbonic acid, paraffin, asphalt, carbonates and other impurities that form scale, blockages or otherwise degrade pipeline equipment. Chemical Injection units are commonly used for storing emulsion breakers, paraffin inhibitors, corrosion inhibitors, demulsifiers and the like. The gas and oil is treated with anti-scale agents, lubricants, surfactants and other chemicals that protect equipment and prevent impurities in the gas from condensing out onto the pipeline equipment. These proposed changes would require in situ monitoring, including interior tank pressure monitoring. Importantly, the current per-unit cost for low pressure sensors for hazardous application is nearly equal to the cost of the chemical injection tank itself.

What is needed is an inexpensive pressure sensor, accurate in low and ultra-low pressure environments that is accurate and capable of prolonged, uninterrupted in situ service with hazardous chemicals.

### BRIEF SUMMARY OF THE INVENTION

The present invention is directed to in situ monitoring of low pressure, hazardous chemicals. A pressure sensor system is presented for accurately measuring low and ultra-low pressures. A sealed pressure bladder is formed from a pliable, yet chemically resistant material fluoropolymer, such as FEP (fluorinated ethylene propylene) or PFA (perfluoroalkoxy polymer sometimes referred to improperly as MFA). FEP has a working temperature of between −100° F. and 400° F., is chemically inert, a good transmitter of ultraviolet rays and, importantly, chemical and corrosion resistance. The texture of FEP fluoropolymer ranges between somewhat pliable to very soft and, therefore, may need additional structural support in certain applications. The pressure bladder is filled with an inert, non-reactive, stable fluid and is hydraulically coupled to a pressure sensor for measuring pressure. The fluid fills the pressure bladder and a measurement chamber of the pressure sensor. The pressure bladder is immersed in a fluid medium contained in a reservoir for monitoring the pressure of the fluid medium. Optimally, the pressure sensor's electronics are hydraulically isolated from the fluid medium and the hydraulic pressure of the reservoir. The pressure sensor is electrically connected to external electrical conductors that provide an electrical connection to electrical monitoring/processing equipment for powering the sensor and receiving its output signals. This bladder configuration insulates the internal components of the pressure sensor from the fluid medium contained in the reservoir, in so doing is particularly useful for monitoring the pressure of hazardous mediums.

In accordance with one exemplary embodiment of the present invention, the pressure bladder forms substantially cylindrically shaped interior chamber having a closed distal end and an open proximate end. The open end of the cylindrically shaped interior chamber is hydraulically coupled to a substantially cylindrically shaped support mandrel with a second substantially cylindrically shaped interior chamber. The second substantially cylindrically shaped interior chamber has a smaller diameter than the bladder and the walls of the mandrel are much thicker, thereby forming a more rigid cylinder. The capillary tube provides a hydraulic path for the fluid that transmits pressures between the pressure bladder and sensor.

The support mandrel serves three purposes: it provides the rigidity necessary for securing a hydraulic fitting for isolating the sensor from the reservoir; it provides a path between the pressure bladder and sensor for communicating pressures; and it provides a structure for mechanically coupling the sensor. Fluoropolymer materials lend themselves to various economical fabrication techniques. Fluoropolymer rods can be easily drilled and shaped. They form good hydraulic coupling with other types of plastic, metals and ceramics. Fluoropolymer materials can be permanently jointed together. Most fluoropolymers, including PTFE, FEP, PFA or ETFE, can be welded and FEP welds form secure, strong and waterproof joints.

Although many off-the-shelf (OTS) pressure sensors are fitted with a barbed port for connecting to a flexible tube, a more secure connection with the mandrel is achieved by trimming the barbed fitting with the threaded die, thereby fashioning a male thread on the sensor, and then using that threaded port for attaching the sensor to the capillary tube of the mandrel.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 is a cross-sectional diagram of a deflection-type pressure sensor as known in the prior art and as is typically used in industry;

FIG. 2 is a cross-sectional diagram of a piezo-type pressures sensor that makes use of a piezo-electric (piezo-resistive) material as known in the prior art and as is typically used in industry;

FIG. 3 is a cross-sectional diagram of a generic low pressure sensor system in accordance with various exemplary embodiments of the present invention;

FIGS. 4A-4H are cross-sectional diagrams depicting steps is fabricating a generic low pressure sensor system in accordance with one exemplary embodiment of the present invention;

FIG. 4B1 is a series of diagrams depicting FEP tubing coupling using a support mandrel having a smaller outer diameter than the pressure bladder in accordance with one exemplary embodiment of the present invention;

FIG. 4B2 is a series of diagrams depicting FEP tubing coupling using a support mandrel and a pressure bladder with identical outer diameters in accordance with one exemplary embodiment of the present invention;

FIG. 4G1 is a cross-sectional diagram of pressure sensors with barbed fitting connection to the mandrel and a spiral wire nut tubing clamp in accordance with one exemplary embodiment of the present invention;

FIG. 4G2 is a cross-sectional diagram of pressure sensors with threaded fitting connection to the mandrel in accordance with one exemplary embodiment of the present invention;

FIG. 4G3 is a cross-sectional diagram of pressure sensors with spiral barbed fitting connection to the mandrel and a crimp tubing clamp in accordance with one exemplary embodiment of the present invention;

FIGS. 5A and 5B are cross-sectional diagrams depicting the components of a pinched-end variant of a generic low pressure sensor system in accordance with one exemplary embodiment of the present invention;

FIGS. 6A and 6B are cross-sectional diagrams depicting the components of a capped end variant of a generic low pressure sensor system in accordance with one exemplary embodiment of the present invention;

FIGS. 7A and 7B are cross-sectional diagrams depicting the components of a plugged end variant of a generic low pressure sensor system in accordance with one exemplary embodiment of the present invention;

FIGS. 8A and 8B are cross-sectional diagrams depicting the components of a continuous diameter variant of a hemispheric-nosed, generic low pressure sensor system in accordance with one exemplary embodiment of the present invention;

FIG. 9 is a cross-sectional diagram of continuous diameter low pressure sensor system 900, mounted across a pressure barrier in accordance with one exemplary embodiment of the present invention;

FIGS. 10A and 10B are cross-sectional diagrams of an immersion-type low pressure sensor system in accordance with one exemplary embodiment of the present invention;

FIG. 10C depicts both a longitudinal cross-sectional view and a perpendicular cross-sectional view of ear weld type coupling weld 1050 in accordance with one exemplary embodiment of the present invention;

FIG. 10D depicts both a longitudinal cross-sectional view and a perpendicular cross-sectional view of upper annular stand-off 1010A and lower annular stand-off 1010B;

FIGS. 11A, 11B, 11C and 110 show possible placements for low pressure sensor system assemblies in typical storage tanks, gas, liquid and multi-phase towers, tanks and separators, light weight chemical tanks and transportation tanks, e.g., truck, rail or marine;

FIGS. 12 A and 12B are conceptual diagrams that graphically illustrate the operating principle behind a piezo-type pressure sensor;

FIGS. 13A, 13B and 13C are conceptual diagrams that graphically illustrate the operating principle of a deflection-type pressure sensor;

FIGS. 14A, 14B and 14C are conceptual diagrams that graphically illustrate the operating principle of a deflection-type pressure sensor having a greater piston ratio with that discussed above with regard to FIGS. 13A, 13B and 13C;

FIGS. 15A and 15B are cross-sectional diagrams of a deflection-type pressure sensor used on a generic low pressure sensor system in accordance with one exemplary embodiment of the present invention;

FIGS. 16A and 16B are cross-sectional diagrams of a deflection-type pressure sensor assembly similar to that depicted in FIGS. 15A and 15B, but with an extended pressure bladder to enhance the measurement range of pressure readings from the low pressure sensor used in a generic low pressure sensor system in accordance with one exemplary embodiment of the present invention;

FIG. 17 is a cross-sectional diagram of generic low pressure sensor system 300 in a dynamic configuration with collapsible gauging pig 1704, for inspecting the condition of the interior walls of a vascular system in accordance with one exemplary embodiment of the present invention;

FIGS. 18A-18E are cross-sectional diagrams illustrating an exemplary fabrication process for modifying generic low pressure sensor system 300 with secondary pressure bladder 1805 in accordance with exemplary embodiments of the present invention;

FIG. 18F is a cross-sectional diagram of generic low pressure sensor system 300 modified with secondary pressure bladder 1805 and secondary interior chamber 1804 to protect the pressure sensor in the event that the outer pressure bladder is compromised in accordance with exemplary embodiments of the present invention;

FIG. 19A is a cross-sectional diagram of flow control low pressure sensor system 1900 for obstructing fluid flow across the mandrel section using sealing balls in accordance with exemplary embodiments of the present invention;

FIG. 19B is a cross-sectional diagram of flow control valve configured with multiple sealing balls in accordance with exemplary embodiments of the present invention; and

FIG. 19C is a cross-sectional diagram of flow control valve configured with a single, larger sealing balls in accordance with exemplary embodiments of the present invention.

Other features of the present invention will be apparent from the accompanying drawings and from the following detailed description.

### DETAILED DESCRIPTION OF THE INVENTION

### Element Reference Number Designations

100: Deflection-Type Pressure Sensor
102: Case
103: (Pressurized) Fluid Medium
104: Biased Diaphragm
105: Measurement Chamber
106: Magnet
108: Hall Effect Linear Position Sensor
110: Connection Pins
112: Diaphragm Isolation Seal
114: Protective Cap
200: Piezo-Type Pressure Sensor
202: Case
204: Base
206: Piezo-Electric Die
207: Contacts
208: Signal Amplifying Electronics
210: Connection Pins
300: Generic Low Pressure Sensor System
302: OTS Low Pressure Sensor
303: Temperature Thermistor
304: Capillary Channel
305: Support Mandrel
306: Internal Pressure Chamber
306-1′: Internal Pressure Chamber (Length l₁′)
306-2′: Internal Pressure Chamber (Length l₂′)
307: Pressure Bladder
307-1: Pressure Bladder (Length l₁)
307-1′: Pressure Bladder (Length l₁′)
307-2′: Pressure Bladder (Length l₂′)
308: Measurement Fluid
309: Hazardous Fluid Medium
310: Compression Fitting/Tube Nut
312: Male Threaded Port/Coupling
315: Compression Fitting (Pressure Isolator)
400: Low Pressure Sensor System (Large
Diameter Bladder)
402: Workpiece Vice
404: Heat Welding
410: Coupling Weld
412: Closure Weld
413: Pressure Test Apparatus
414: Barbed Port
415: Oil Fill Apparatus
416: Spiral Barbed Port
422: O-Ring (Q-Ring)
426: Spiral Wire Nut Tubing Clamp
428: Crimp Tubing Clamp
600: Low Pressure Sensor System (Bladder
Cap)
602: Bladder Cap
700: Low Pressure Sensor System (Bladder
Plug)
702: Bladder Plug
800: Low Pressure Sensor System
(Hemispheric Bladder)
805: Coaxial Support Mandrel
807: Hemispheric Pressure Bladder
900: Low Pressure Sensor System Assembly
(Exposed Sensor and Coaxial)
904: Capillary Channel
905: Support Mandrel
906: Internal Pressure Chamber
907: Full-Length Pressure Bladder
916: Conductors
917: Conductor Tubing
920: Inner Shrink Tubing
921: Threaded Collar
922: Intermediate Shrink Tubing
924: Outer (FEP) Shrink Tubing
930: Lower Compression Fitting
932: Upper Compression Fitting
934: Upper Lock Nut
940: Protective Pipe
942: Rigid Cure Spray Foam
1000: Submersible Low Pressure Sensor
System Assembly
1004: Capillary Channel
1005: Mandrel
1006: Internal Pressure Chamber
1007: Full-Length Pressure Bladder
1010A: Upper Annular Stand-Off
1010B: Lower Annular Stand-Off
1016: Conductors Tubing
1017: Conductor
1020: Inner Shrink Tubing
1022: Intermediate Shrink Tubing
1024: Isolating (FEP) (Shrink) Tubing
1026: Protective (FEP) Shrink Tubing
1050: Coupling Weld (Ear Weld)
1055: Ballast Weights
1500: Deflection-Type Low Pressure
Sensor System (Short Bladder)
1501: Deflection-Type Low Pressure

[symbol]

1702: Tubing/Vascular Structure
1704: Collapsible Gauge Pig
1712: Contaminant Build-up
1713: Tubing Wall Thickening/Kinks
1716: Tubing Tether
1717: Conductor
1720: Fluid Medium
1800: Double Bladder Low Pressure
Sensor System
1802: Annular Sleeve
1804: Primary Internal Pressure
Chamber
1805: Secondary Pressure Bladder
1806: Primary Internal Pressure

[symbol]

1807: Primary Pressure Bladder
1816: Air Escape Tube
1900: Flow Control Low Pressure Sensor
1903: Upper Mandrel
1904: Capillary Channel
1905: Lower Mandrel
1906: Internal Pressure Chamber
1907: Pressure Bladder
1910: Pressure Bladder
1920: Flow Control Valve
1922: Multiple Sealing Balls
1923: Single Sealing Ball
1924: Conical-Shaped Sealing Surface [symbol]
indicates data missing or illegible when filed

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals.

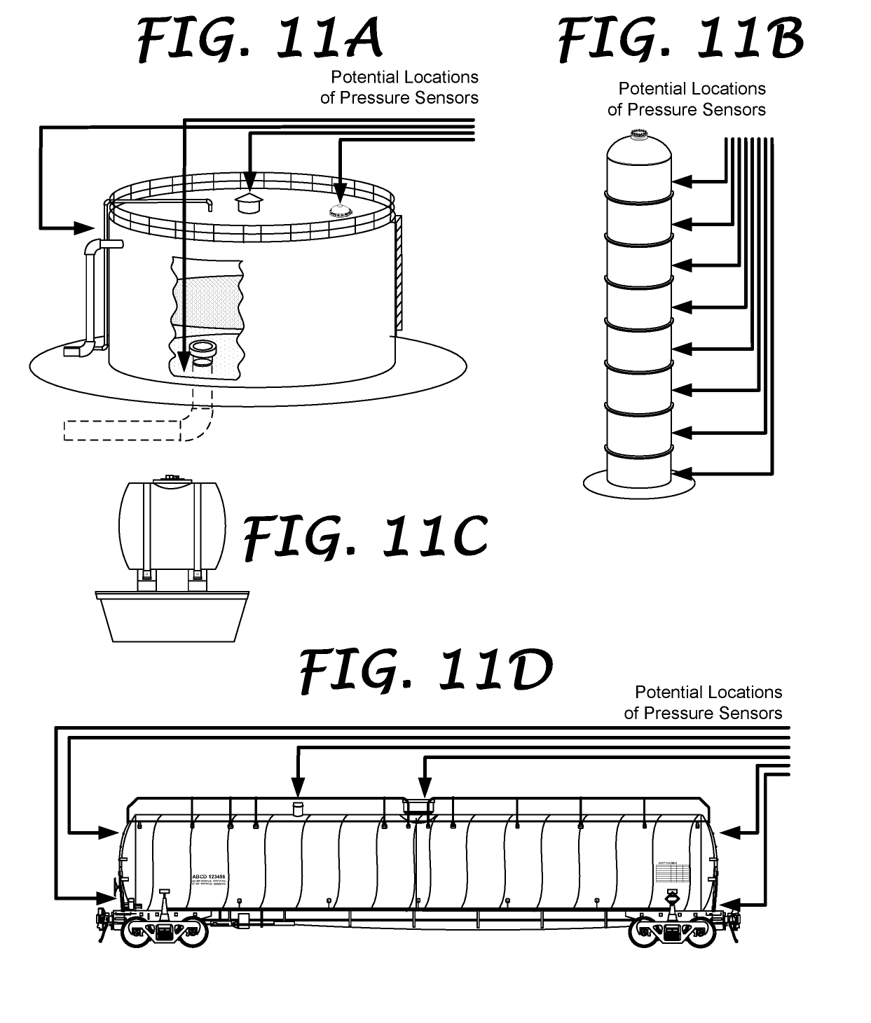

The need for accurate low pressure monitoring abound in industry, especially chemical, petroleum, transportation and facilities management. Storage tanks, i.e., gas, petroleum, chemical, water, etc. (see storage tank in FIG. 11A) regularly utilize pressure sensors for monitoring their internal pressures. Often, vertical pressure gradients within a storage tank are somewhat complication, especially if the tank contains multi-phase and/or multi-density materials. Low pressure sensors offer the managers a cost efficient approach for not only monitoring the tank for unsafe operating pressure levels, but also, when positioned at the tanks' bottoms, an indicator of fluid level as well as the fluid types present in the tank. FIG. 11A shows some possible placements for typical storage tank applications, that is, near the tank bottom, fill port, proximate to the pressure relief and thief hatches, among other possible locations.

Another application where monitoring accurate pressure values is critical is in gas, liquid and multi-phase towers, tanks and separators (see separator tank in FIG. 11B). Separators operate by segregating mixed fluids and gases (such as crude mixes from oil and gas wells) into their individual and unique species, usually by heat-treating the raw compound. Typically, separators are used for separating gases, but are sometimes used for fluid separation. In so doing, different species of gases (or liquids) will migrate to a particular vertical level and can then be extracted as a purified gas specie (or fluid). While maintaining the proper internal temperatures is crucial for effective separation, maintaining vertical head pressures is likewise important. Typically, the extraction levels are determined by the types of specie gases in the mix. As the mix is heated, the individual gas species will separate at a vertical height equivalent to the hydrostatic head for that specie. Whenever unknown and/or unwanted compounds or species are present, the vertical specie separation levels may change, such as when water or other dense liquids collect at the bottom of the tower. By monitoring the pressures at critical vertical separation heights on the tank, operators can better understand if unwanted compounds are entering or collecting in the tower and make adjustments on the fly. FIG. 11B shows some possible placements for typical separator tank applications, that is, near the tank bottom, and, typically, at each specie vertical extraction level.

Still another, and possibly most controversial application for monitoring pressure values is in small, usually independently operating, chemical injection tanks (see chemical tank in FIG. 11C). Historically, these tanks were fabricated from steel, which was expensive, ionically unstable and required periodic maintenance for corrosion inhibition, such as painting. Later, fiberglass tanks began replacing the steel, which in many cases were cheaper to produce, generally more durable, less susceptible to corrosion, and required less corrosion maintenance, however, they are highly susceptible to exposure to direct sunlight (exposure to ultraviolet light causes a condition known as fiber-bloom where the resin degrades, exposing layers of pure fiberglass, weakening the structure). Recently, these tanks have been replaced by injection molded tanks, fabricated from poly (polyethylene) materials (or in some cases acrylics) as a seamless one-piece construction, semi-rigid from medium or high density poly, with a medium thickness, and formed without seams and joints where leaks in metal and fiberglass tanks tend to occur. These poly tanks are less labor intensive to produce and therefore, generally cheaper, but must be protected from UV light, usually by the addition of UV light stabilizers in the molding process. During the last ten years the proliferation of these tanks has exploded, into the hundreds of thousands of units (not all used for chemical injection applications). Many chemical injection applications are for use at hydrocarbon producing wellheads, pipelines or pumping/pressure stations. Their purpose is to introduce various chemicals at particular points in the operation. Typically, crude oil and gas contains many impurities that affect laminar pipeline flow, including water, carbonic acid, paraffin, asphalt, carbonates and other impurities that form scale, blockages or otherwise degrade pipeline equipment. These chemical injection units are commonly used for storing emulsion breakers, paraffin inhibitors, corrosion inhibitors, demulsifiers and the like. In so doing, the pipeline transport of these products are increased greatly and mechanical failure reduced.

Structurally, these types of chemical tanks cannot support an internal pressure or vacuum. By design, they rely exclusively on open venting for equalizing the tank's internal pressure. Furthermore, chemical injection tanks of the types discussed here are typically manufactured with a delivery port near the bottom of the tank, in order to accommodate gravity feed rather than internal pumps to reduce the chance of a tank implosion from a vacuum condition created by suction fed pumps. Chemical injection tanks are usually manufactured with integrated poly legs and strap guides for easy mounting on an elevated steel or poly frame. They are usually equipped with an oversized fill port at the top for refilling chemicals. Until recently, the only environmental requirement was the placement of spill containment basin directly under the tank (usually 110% volume of the tank's capacity).

Cracks and splitting have occurred in poly chemical injection, but on extremely rare occasions and are usually as a result of another factor, such as UV degradation, freezing, improper heating or vacuum implosion. However, recent clean air rules that no longer permit the unchecked venting of pipeline injection chemicals into the atmosphere, will require significant upgrades to most of these types of tanks. Firstly, with the exception of filling and maintenance, the injection tanks must be sealed completely and air tight. This greatly increases the likelihood of internal pressure spikes. Also, chemical vapors must be recaptured, usually by recirculating them into the injection system, which increases the likelihood of internal vacuum spikes. Therefore, chemical injection tanks that previously relied on passive monitoring and containment techniques now require active monitoring, especially of internal tank pressure. Fortunately, most chemical injection tanks operate in close proximity of some type of monitoring system, such as the Advantis Monitoring System (AMS) (available from Advantis, L.L.C. in Marshall, Tex.). However, low pressure sensors, of the type suitable for operation with hazardous chemicals, are extremely expensive; a single sensor can cost the equivalent of the 125 gallon poly tank it is intended to monitor.

Finally, maybe the most critical need for the in situ monitoring of internal pressure values is in the transportation industry. At any moment, tens of thousands of chemical tanks are being moved by truck, rail or ship. Accidental discharge of the chemical contents of these tanks usually occur in one of three ways: transportation related accident (collision, derailment, or grounding), uncontrolled reaction (a rapid or unexpected change in the properties of the chemical contents of the tank), or mechanical failure (a leak developing in one of the tank's systems). Of the three, transportation related accidents are usually considered the most dangerous, and, although marine accidents have the potential for releasing much greater amounts of chemicals, rail accidents are considered more dangerous because of the potential spill amount, the proximity to human habitation, as well as shifting weather patterns that may subject entirely different populations to the effects of airborne contaminants. Typically, the response from regulators is almost universal to require more stringent structural and crash guidelines (the “build it stronger” response).

With further reference to the rail industry, new regulations for chemical tanks rail cars, such as that depicted in FIG. 11D, require stronger sidewalls, stronger and more shielded valves and hatched and massively reinforced crash zones at either end of the car. Additionally, new regulations for chemical tank railcars now require modified undercarriage designs, improved couplers and more advanced braking systems with increased braking capacity and emergency backup. Similar regulations have been proposed or implemented in the over-the-road trucking industry. Monitoring the state of the chemical contents has, while not always addressed directly, been a concern. The thought was that if the tanks were structurally sound, the uncontrolled reactions of the chemical contents is minimized, if not averted altogether. Furthermore, upgrading hundreds of thousands of rail and truck tanks for real-time monitoring is cost prohibitive, especially with regard to the extremely low risk of failure and the trucking and rails industries hardline stance against these upgrades. These attitudes seem to be changing, especially in view of the EPA's new guidelines toward accidental releases into the environment. Also, as the cost of real-time communication platforms decrease (satellite, mobile and spot WIFI) and the availability and bandwidth increases, the costs associated with having real-time data links to chemical tanks may drop costs to near the low risk of a chemical release. Ideally, each chemical railcar, trailer or marine tank would be fitted with in situ monitoring system (including, at least, temperature, pressure, explosion and level sensors) and a designated communication link to a centralized monitoring and safety facility for the corporation owning/managing the tank. Operators can then, interrogate the state values of the chemical cargo from the monitor readings, then, knowing the exact contents of the tank, compare the in situ monitored values with known physical state values for the chemical, and take appropriate action as necessary.

In addition to the in situ monitoring systems and communications link described above, each tank would require an electrical power supply and, perhaps, a backup source. For rail cars, this probably requires modifying each car with a system of rechargeable batteries and a generator, probably mechanically coupled to its wheels. An alternative proposed by the Department of Transportation is to place electronic interrogators at fixed locations along the rail- or road-way. These electronic interrogators would optically identify the tank for identifying numbers or patterns (or by RFID) and then simultaneously interrogate passing tanks using an onboard transceiver coupled to the monitoring system by issuing a specific ‘wake-up’ call to the tank based on the tank's unique identification. These transceiver interrogation systems are well known and in extensive use in the utilities industry, water and gas especially, wherein a transceiver, powered by a lithium battery, is connected to the water (or gas) meter and is “read”, or interrogated by a reader vehicle as it passes the property location. With regard to the transportation industry, the reading received at the integration location would be immediately passed to the owner/operators of the tank, who then verify that the monitored values are within tolerances for the chemical being transported. If not, the driver/operator is notified and given precise instructions. Interestingly, the DOT further proposes designated safe areas where a tank can be parked for servicing. With regard to rail, DOT has proposed creating and improving emergency spurs for the fast decoupling of single cars for safe servicing. The Department of Homeland Security, although not directly involved, has endorsed these improvements in its counterterrorism efforts.

Here again, with regard to the transportation of chemical tanks, the relative expense of low pressure sensors capable of accurate operation in hazardous conditions is a paramount concern for regulators and operator. What is needed is an accurate low pressure sensor, extremely reliable, relatively inexpensive pressure sensor, but that can be exposed to and operate in hazardous materials.

Before continuing, it should be mentioned that some sources make a distinction between sensors and transducers and provide varying support for the distinctions between the types of pressure measuring devices. For the purposes of the descriptions of the present invention, the term pressure sensor and the term pressure transducer may be considered as synonymous, as both will sense a pressure as a physical quantity and then transform that pressure quantity into a signal (electrical). Inexpensive pressure sensors exist. Highly accurate pressure sensors exist that are relatively inexpensive. However, none of the aforementioned sensors will operate in hazardous environments.

Typically, sensors that are designed to operate in hazardous environments have the pressure sensing element shielded by a material that will not degrade with exposure to a wide range of reactants, oxidizers, corrosives and other classes of hazardous materials and one that will communicate external pressure internally, to the pressure sensing material. This is often a rather difficult engineering feat, and expensive. One exemplary means for accomplishing these objectives is to, essentially, transform a stress gauge into a pressure sensor (not shown in the drawings). A material is selected to form a semi-elastic membrane that is both strong (pressure resistant) and resistant to hazardous materials. The membrane provides a hydraulic seal for the device. On the external side of the membrane, strain-sensitive material is deposited, often in a pattern of multiple strips. When the device is exposed to pressure, the membrane stretches and the strain-sensitive material measures the stress in the membrane. Onboard electronics transforms the strain measurement to a pressure measurement. As might be appreciated, because of the relative complexity of the device, higher precision and quality materials are used in the fabrication, which, again, adds to expense.

In accordance with exemplary embodiments of the present invention, a cost-effective, precision, low pressure sensor system is disclosed for in situ pressure monitoring of a variety of fluid medium types, including hazardous materials. The term “fluid” should be understood as meaning any fluid, liquid or gas. One objective of the present invention is to utilize proven components that are available in bulk, in order to reduce cost and assure reliability, especially the pressure sensor itself. As mentioned elsewhere above, low-cost, accurate pressure sensors for monitoring low pressure fluids are plentiful, but not for hazardous environments. The aim is to protect the pressure sensor from the hazardous mediums it monitors. Therefore, in accordance with one exemplary embodiment of the present invention, generic low pressure sensor system 300 (depicted in FIG. 3) is disclosed which comprises three basic components: a pressure sensor; a support mandrel; and a pressure bladder. Generic sensor 302 is any of a variety of off-the-shelf (OTS), low-cost, low pressure sensors, such as the ABP series of basic board mount sensors available from the Honeywell Corporation of Golden Valley, N. Mex.

OTS low pressure sensor 302 measures the pressure of measurement fluid 308 which is encapsulated in interior pressure chamber 306 of pressure bladder 307. Pressure bladder 307 is comprised of an extremely pliable material and is exposed to an external pressure, p₁, to be measured, such as in a closed system, for example pressurized fluid mediums in pipes, tubes, conduits, vascular/arterial structures, containers, chambers, tanks, etc. In so doing, the external pressure, that is the medium pressure, p₁, (such as the exemplary tank's internal pressure) is transferred from the exterior of pressure bladder 307 into mandrel measurement fluid 308 contained in the bladder's interior pressure chamber 306, depicted as interior pressure, p₁′. Although it is physically possible to hydraulically couple pressure bladder 307 directly to OTS low pressure sensor 302, this type of connection is rather complicated and, for some applications, a pressure interface should be created to isolate OTS low pressure sensor 302 from the exterior pressure (for example the tank pressure), or at least from contact with the fluid being measured (the contents of the exemplary tank). For most applications, OTS low pressure sensor 302 should be coupled to a more rigid structure than pressure bladder 307. Hence, support mandrel 305 is interposed between OTS low pressure sensor 302 and pressure bladder 307. Support mandrel 305 serves three purposes: it provides a structure for capillary channel 304 for measurement fluid 308 to communicate interior pressure, p₁′, between interior pressure chamber 306 of pressure bladder 307 and the measurement chamber of OTS low pressure sensor 302; support mandrel 305 also provides the additional structural integrity necessary for hydraulically coupling to OTS low pressure sensor 302; and finally, support mandrel 305 provides the additional lateral integrity necessary for supporting a pressure interface to seal in exterior pressure p₁, (within (pressurized) fluid medium 103) e.g., using compression fitting 315.

In accordance with yet another exemplary aspect of the present invention, pressure bladder 307, as well as support mandrel 305, are fabricated from a chemical resistant material that is impervious to most types of corrosives, reactants, oxidizers and other hazardous materials. In addition, the present invention is equally functional in non-hazardous environments, such as municipal water reservoir tanks and other potable water containers, as well as food grade shipping tanks and the like. One such chemically resistant material is a class of fluoropolymers. Exemplary fluoropolymers include fluorinated ethylene propylene (FEP), perfluoroalkoxy polymer (PFA) (sometimes referred to improperly as MFA), polytetrafluoroethylene (PTFE), ethylene tetrafluoroethylene (ETFE) and others. In general, these fluoropolymer materials have high corrosion resistance, strength over a wide temperature range, most are easily welded and have high electrical resistivity. Fluoropolymers, of the type polymers described immediately above, have several distinct advantages over the materials typically used in the prior art to isolate pressure sensors from the hazardous fluid mediums. First, fluoropolymer materials lend themselves to various economical fabrication techniques, they are infinitely configurable and available in many forms (sheet, round stock, square stock, tubular, etc.). Fluoropolymer materials can be cut, bent and shaped into precise geometries using relatively inexpensive manufacturing equipment. For example, fluoropolymer rods can be easily drilled and shaped; fluoropolymer sheets and tubing can be welded together or to one another; and standard polymer welding techniques yield excellent hydraulically coupling without the use of adhesives. Many types of fluoropolymers are available in a wide range of durometers (Shore hardness). Most of these fluoropolymers are available in quantity and extremely cost effective (as an example, the materials cost for fluoropolymer bladder and mandrel for generic low pressure sensor system 300 is less than five percent (5.0%) of the cost of a suitable pressure sensor for the device (excluding the costs associated with fabrication). Most importantly, many fluoropolymers are resistant to a wide range of corrosive and reactant chemicals, they will not oxidize, are chemically inert and UV stable.

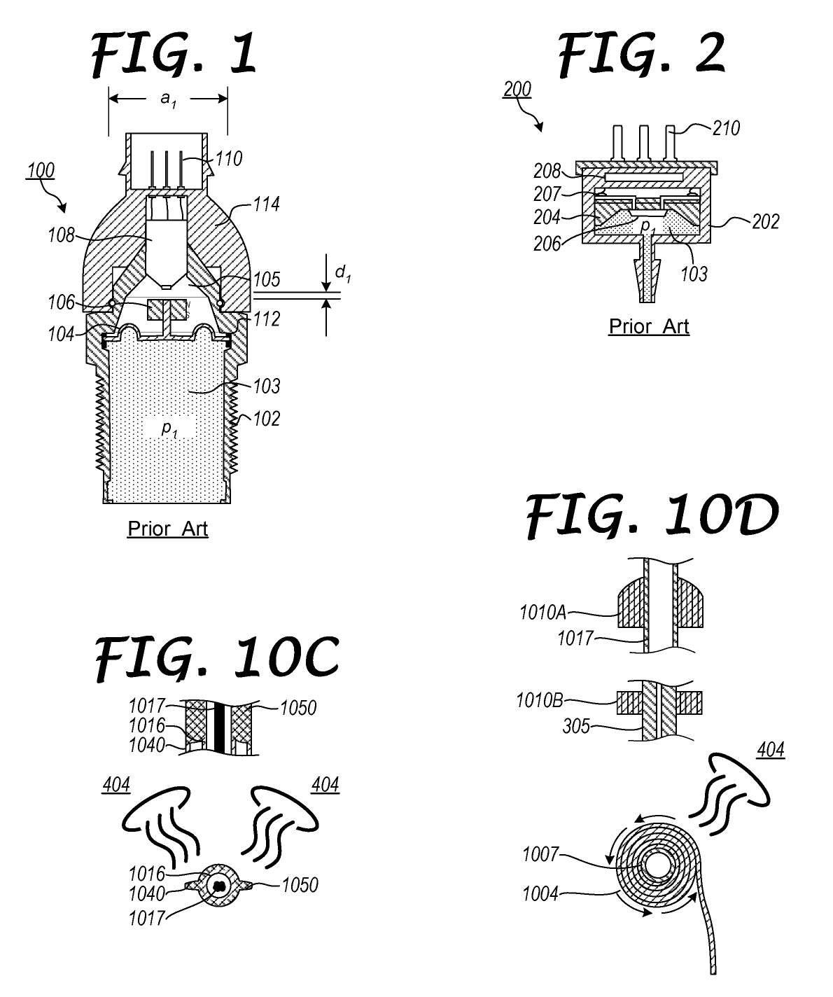

Returning to generic low pressure sensor system 300 depicted in FIG. 3, the type of pressure sensor employed is relatively unimportant for implementation of the presently described invention. OTS low pressure sensor 302 may be of any type pressure sensor, such as for example, piezoelectric-type pressure sensor 200 described with regard to FIG. 2 or deflection-type pressure sensor 100 described with regard to FIG. 1.

Here it should be mentioned that many off-the-shelf pressure sensor exhibit temperature induced measurement shifts of their pressure readings. Operating in exposed areas, sometimes with wide temperature variations, such as in direct sunlight and cold nights, or adjacent to or immersed in hot or alternative hot and cool fluids, may induce a shift in the sensor's readings. These measurement shifts may be linear and predictable, but more often they are non-linear and/or not readily predictable. Therefore, for accurate pressure readings, a temperature correction should be formulated for the particular OTS low pressure sensor being employed. Ideally, this is accomplished by creating a comprehensive table of temperature-corrected pressure readings. Typically, a pressure sensor is exposed to a range of environmental temperatures (e.g., −10 degrees Fahrenheit to 140 degrees) for each rated pressure increment of the sensor (e.g., 0 psi-30 psi). Hence, temperature thermistor 303 is optimally provided for monitoring the temperature of OTS low pressure sensor 302 in order to determine the temperature induced pressure correction. For example, an OTS pressure sensor may read 10.0 psig (per square inch gauge) which is the correct fluid medium pressure and requires no pressure correction at 77 degrees Fahrenheit. However, a 10.0 psi fluid pressure reading taken at 37 degrees Fahrenheit (40 degrees lower than the original 77 degrees) will result in a pressure reading of 9.6 psig, thus requiring a temperature correction of 0.4 psi (0.4 psi @ 37 degrees Fahrenheit). But measuring 10.0 psi fluid pressure at 117 degrees Fahrenheit (40 degrees higher than the original 77 degrees) the sensor will read 11.1 psig, necessitating a temperature correction of −1.1 psi (−1.1 psi @ 117 degrees Fahrenheit). The following drawing figures may or may not depict the optional thermistor, however, each of the following embodiments may be provided with a thermistor as necessary for the particular application of the OTS low pressure sensor. In practice, certain OTS low pressure sensors are provided with a thermistor integrated within its electronic circuitry.

The OTS pressure sensor, while extremely accurate in sensing pressures over its pressure range at its rated operating temperatures, is extremely susceptible to many types of corrosives, reactants, oxidizers and other hazardous materials. Therefore, the OTS pressure sensor must not be exposed to any of these types of materials. The OTS pressure sensor must, therefore, not be used in a hazardous environment, or, in accordance with various embodiments of the present invention, be isolated from any hazardous materials. This is accomplished by providing an isolation interface between the pressurized hazardous medium and the OTS pressure sensor. This isolation interface must be both resistant to hazardous materials and yet be transparent to pressures.

In accordance with one exemplary embodiment of the present invention, the OTS pressure sensor is isolated from the pressurized fluid medium being monitored by using a chemically inert and resistant material as an interface, but that is transparent to the pressure to be monitored in highly hazardous fluids, such as a fluoropolymer. Returning to the description associated with FIG. 3, in practice pressure bladder 307 and support mandrel 305 may be fabricated from FEP (fluorinated ethylene propylene) which has yielded excellent results. It should, however, be appreciated that that FEP is an exemplary material and other fluoropolymers may yield equally suitable results for hazardous environments, either those presently available, or those that may become available in the future.

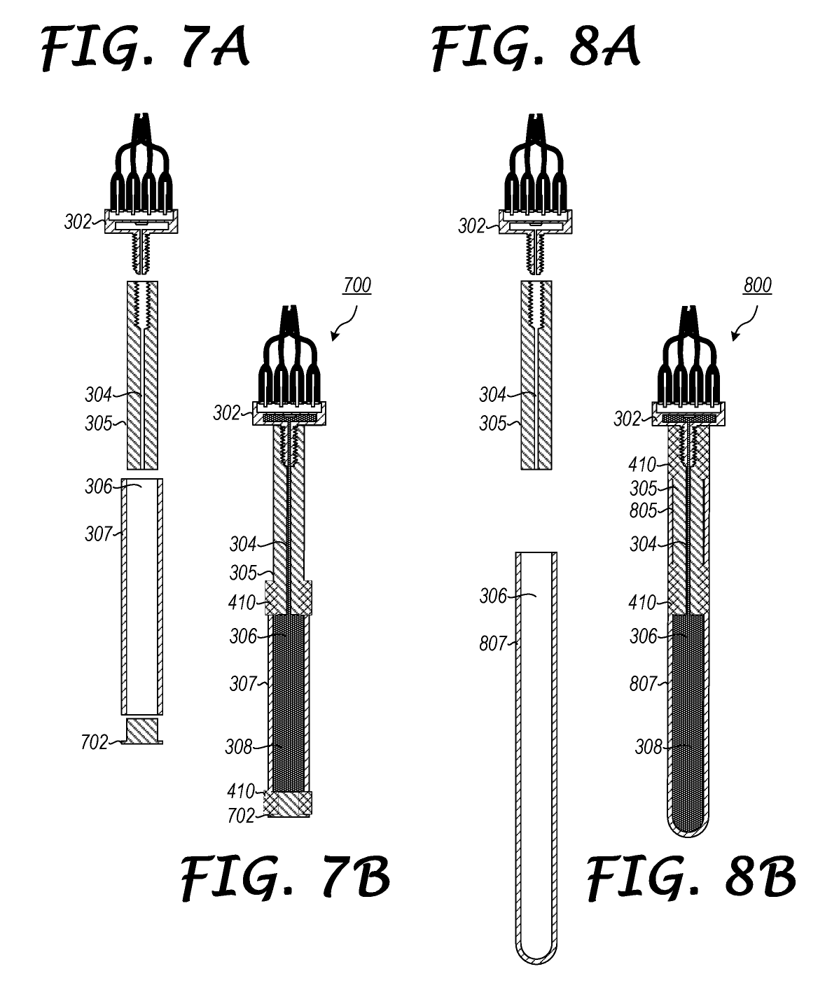

Fabricating the FEP structure for isolating the pressure sensor is relatively uncomplicated, extremely cost-effective and highly adaptable for different applications and design criteria. One exemplary technique involves fashioning pressure bladder 307 and support mandrel 305 from a single length of round-stock FEP. The diameter and length of FEP round stock is selected, and then capillary channel 304 is bored through the round-stock bar. Next, interior pressure chamber 306 is formed by boring a larger diameter hole across the capillary channel a predetermined depth and then pinch-welding the open end of pressure chamber 306 (alternative, the open end can be plug-welded, see FIGS. 7A and 7B or cap-welded, see FIGS. 6A and 6B). While this operation is extremely uncomplicated, it requires one cut, two boring operations and one welding operation which, cumulatively, can be rather time-consuming. Here it should be mentioned that the welding operations discussed hereinafter, are intended to hydraulically seal components that are exposed to the fluid medium. Other types of hydraulically seals are known, such as tubing claims.

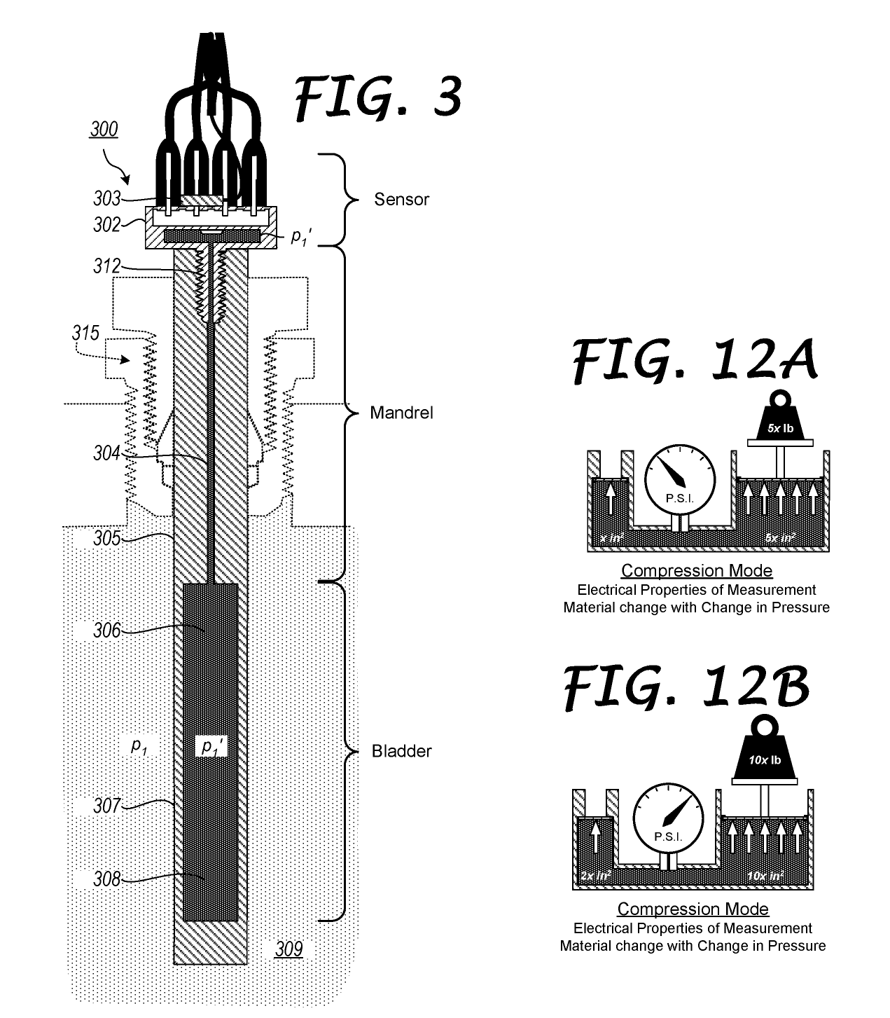

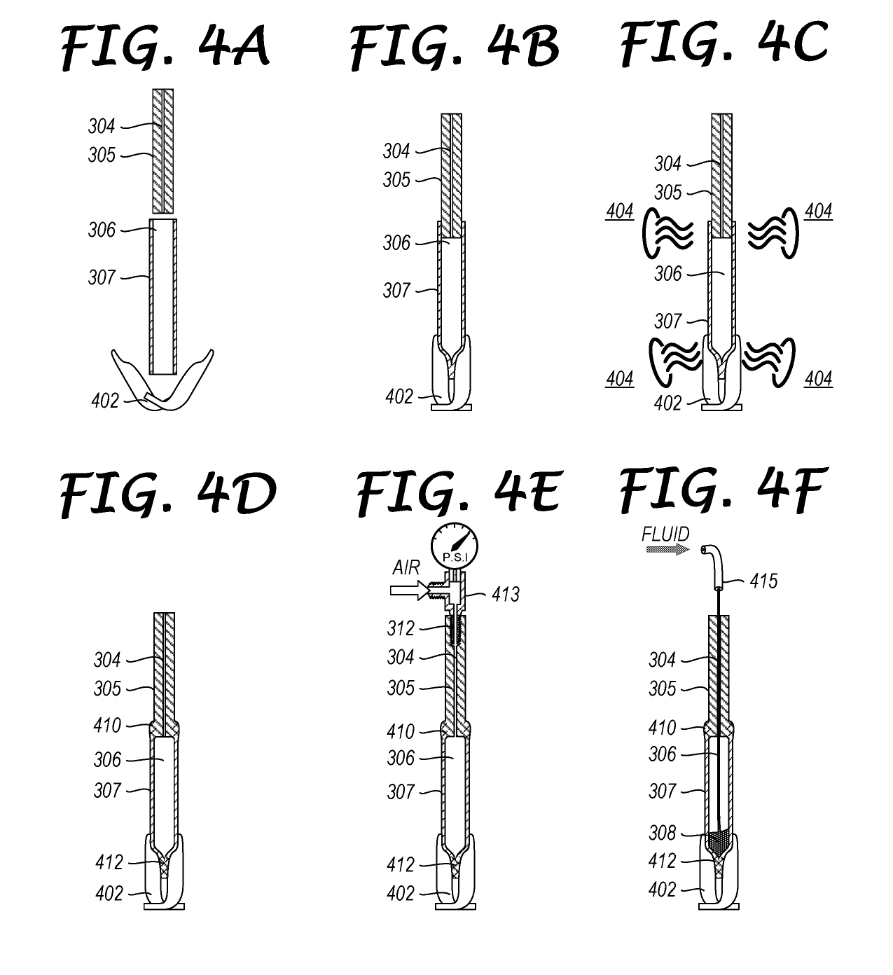

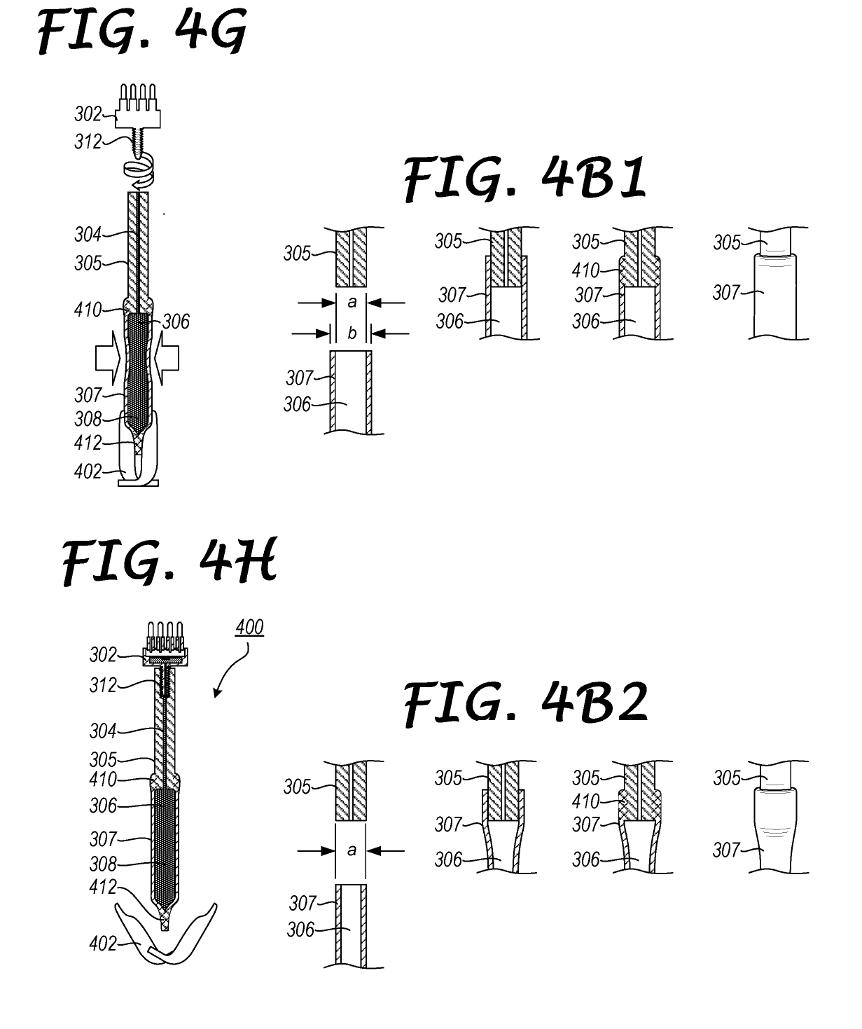

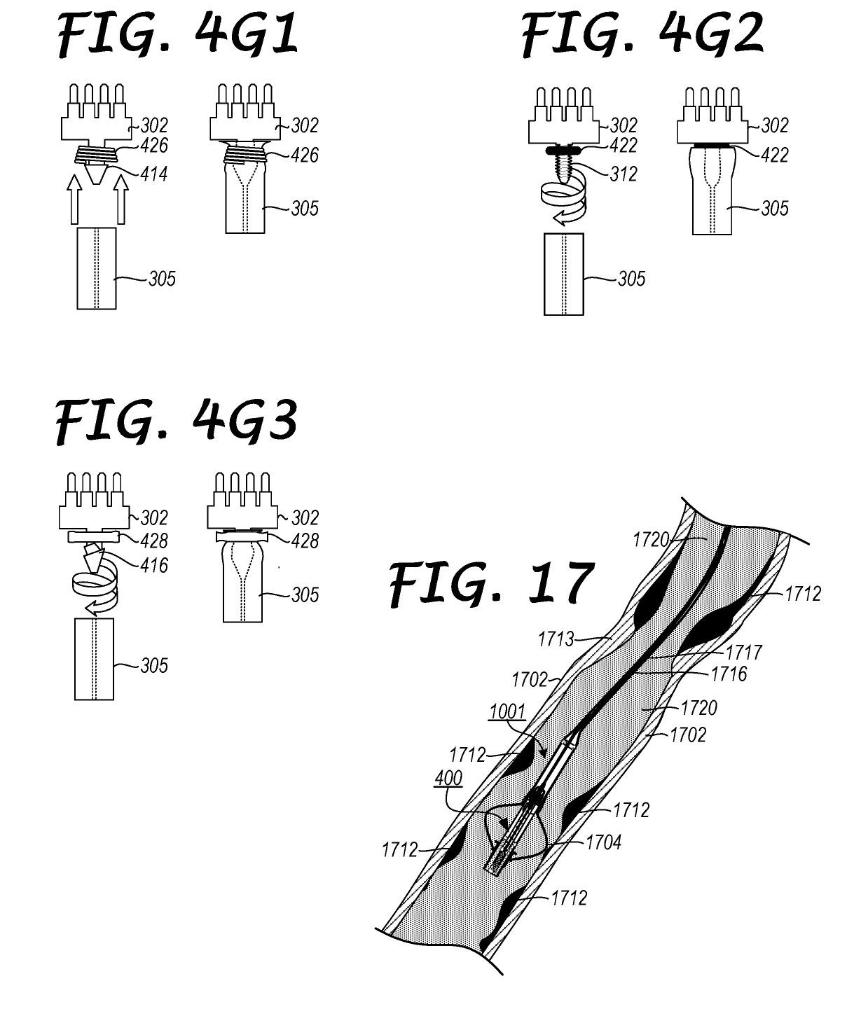

Alternatively, pressure bladder 307 and support mandrel 305 can be cut directly from separate stocks of PEF tubing and assembled as shown in the exemplary fabrication process depicted in FIGS. 4A-4H. The exemplary fabrication process comprises essentially four fabrication operations, cutting, welding, filling and then a final assembling of the components. A sensor system can be manually fabricated and assembled in about a minute. Initially, stock FEP tubes are cut to desired lengths for pressure bladder 307 and support mandrel 305. The length of tubing for pressure bladder 307 depends on the desired length of pressure chamber 306, how far support mandrel 305 tubing will be inserted in the bladder and how much bladder will be pinched off to seal it, see FIG. 4A. Pressure bladder 307 may be supported in workpiece vice 402 during assembly. Support mandrel 305 may be cut long and then subsequently trimmed to a length determined by the specific application for the low pressure sensor system. The bottom of support mandrel 305 is inserted into pressure bladder 307 a predetermined depth, thereby forming pressure chamber 306, see FIG. 4B.

Here, it should be mentioned that using the FEP material enables the manufacturer some flexibility in the diameter of the pressure bladder 307 as depicted in the series of figure drawings depicted in FIGS. 4B1 and 4B2. Series FIG. 4B1 depicts a build using support mandrel 305 having an outer diameter a, and pressure bladder 307 having an outer diameter b and an inner diameter a. In so doing, pressure bladder 307 easily slides over support mandrel 305 and can be welded in place as depicted in the last two drawing frames of the series. Series FIG. 4B2 depicts a build using support mandrel 305 having an outer diameter a, and pressure bladder 307 having an identical outer diameter, diameter a, hence the inner diameter of pressure bladder 307 is less than diameter a. (the outer diameter of support mandrel 305). In so doing, pressure bladder 307 must be stretched over the outer diameter of support mandrel 305. Only then can pressure bladder 307 be welded in place, as also depicted in the last two drawing frames of the series. Using pressure bladder 307 with a larger outer diameter b has the advantage of easily coupling pressure bladder 307 to support mandrel 305 for welding, however stock FEP tubing is generally not available in a particularly wide range of inner diameters. Using pressure bladder 307 with an outer diameter a, identical to the outer diameter of support mandrel 305 has the advantage of being readily available without the need for special ordering, and therefore less expensive. Additionally, notice that the diameter of internal pressure chamber 306 depicted in the series of FIG. 4B1 is larger than that in series FIG. 4B2, thereby increasing the volume of internal pressure chamber 306, which may be important for a particular application.

In any case, returning to FIG. 4C, pressure bladder 307 is FEP welded 404 to support mandrel 305 and the pinched end of pressure bladder 307 is also FEP welded 404, resulting in coupling weld 410 between support mandrel 305 and pressure bladder 307 and closure weld 412 at the pinched end of pressure bladder 307, see FIG. 4D. Next, and optionally, the workpiece may be pressure-tested to verify the welds' strength using pressure tester 413 inserted into capillary channel 304, see FIG. 4E. At this point, fabrication is complete and the sensor can be finally assembled with a pressure sensor.

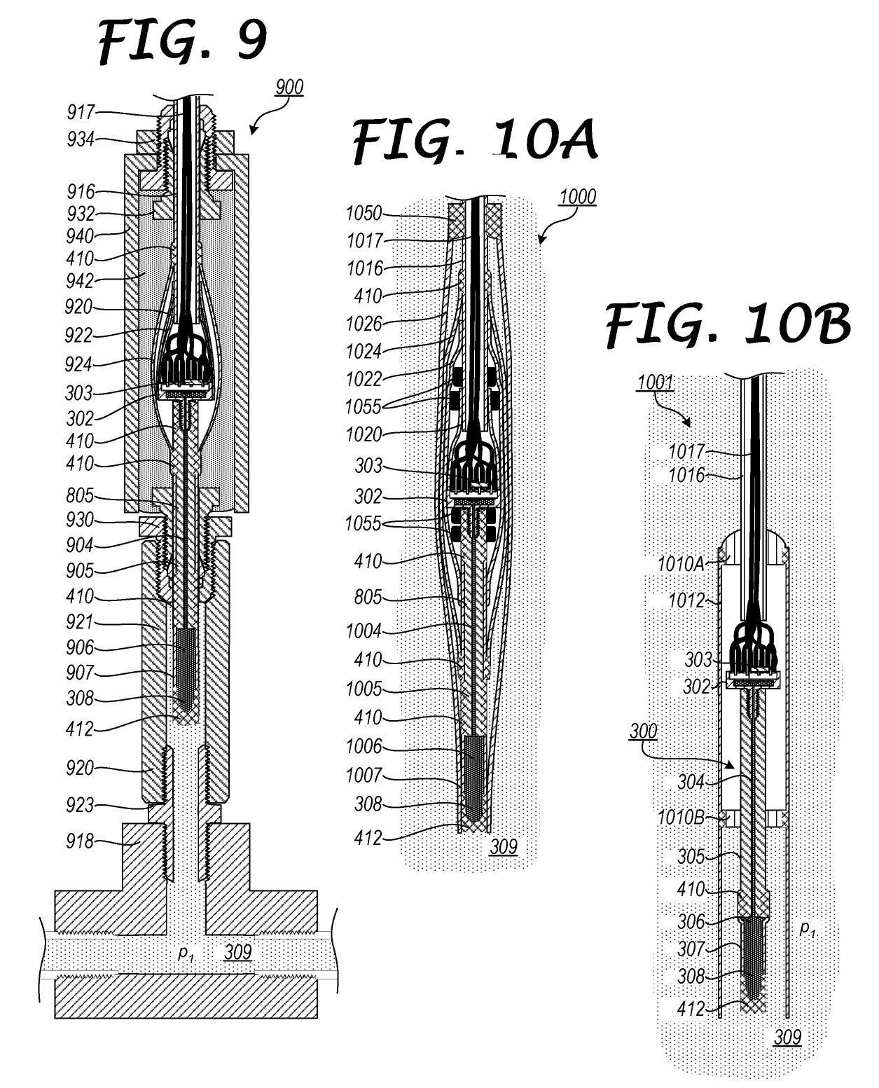

Here it should be mentioned that the present low pressure sensor system can be adapted for two separate operating modes, a distal sensor configuration where the pressure sensor is positioned away from the hazardous medium, see for example FIG. 9 and a proximate sensor configuration where the low pressure sensor is submerged within the hazardous fluid medium, see for example FIGS. 10A and 10B. It is expected that, in either case, that some shielding of OTS low pressure sensor 302 should be provided (the length of the support mandrel being trimmed appropriately).

In any case, once the mandrel is trimmed, measurement fluid 308 is injected through capillary channel 304 (using injection tube 415) and into interior chamber 306 until the chamber and capillary channel are both full and bubble-free, see FIG. 4F. An exemplary measurement fluid 308 is any high grade, non-reactant, non-conductive oil having relatively low viscosity. In order to avoid air bubbles in the system, the low pressure sensors (such as basic sensor 302) are stored, port side up, in a container of measurement fluid 308 until they are needed for assembly. Finally, the low pressure sensor is selected from the container and mechanically coupled to support mandrel 305, see FIG. 4G.

Here, it should be noted that most off-the-shelf basic board mounted pressure sensors, of the type discussed herein, utilize a barbed port fitting for making a connection to a flexible tubing, see basic sensor 302 shown in FIG. 4G1 having barbed port 414. For many applications, using basic sensor 302 with barbed port 414 will provide sufficient mechanical coupling strength without leakage. However, often it is advantageous to use FEP materials with higher Shore Hardness values, especially support mandrel 305 in order to ensure a good coupling (via compression fitting 315) for pressure isolation of the fluid medium. Hence, coupling support mandrel 305 to basic sensor 302 may be difficult using a standard barbed fitting (barbed port 414). Furthermore, good sensor/mandrel mechanical coupling strength is critical for operating safety. One solution is to reconfigure basic sensor 302 with male threads. Male threads on the port simplifies the coupling operation because rather than forcing a barbed fitting into a stiff tube, the sensor can merely be screwed into the tubing. Additionally, for many types of tubing materials, a threaded connection provides greater sensor/mandrel coupling strength. As the exterior cases (and barbed ports) on these sensors comprise a workable plastic composition, male threads can easily be manually cut into barbed port 414 by using a threaded die to form male threaded port 312 as depicted in FIG. 4G2. Alternatively, sensor manufacturers may also provide pressure sensors with spiral barbed port 416 as depicted in FIG. 4G3. Spiral barbed port 416 are not only easier for the fabricator to couple to the mandrel, but also provide greater coupling strength than a standard barbed fitting, such as barbed port 414.

Notice from FIG. 4G that a slight pressure is applied to pressure bladder 307 to deflate the bladder somewhat to accommodate an equivalent volume measurement fluid 308 to be displaced by male threaded port 312 during installation of OTS low pressure sensor 302. OTS low pressure sensor 302 is twisted onto support mandrel 305 and one exemplary embodiment of the low pressure sensor system is complete, i.e., pinched-end mandrel low pressure sensor 400, see FIG. 4H.

As may be appreciated from the following discussions, a coupling failure will result in loss of measurement fluid 308 and failure of the sensor. Additionally, certain types of measurement fluid 308 have a penetrating effect on the coupling joint, causing the measurement fluid to weep out at the sensor-mandrel coupling. In extreme cases, a coupling failure may result in the escape of hazardous material into the environment, for example in an exposed sensor system, such as low pressure sensor system assembly 900. Therefore, preventing the escape of measurement fluid, even slight weeping, and securing the mechanical coupling between the pressure sensor and mandrel are crucial. One mechanism to prevent leaks and weeping is to employ an additional seal, such as O-ring or Q-ring 422 as depicted in FIG. 4G2. O-ring or Q-ring 422 may be used in addition to any other coupling or clamping mechanism employed. Better coupling mechanics is achieved by using a tubing clamp, such as a common spring clamp (not shown), spiral wire nut tubing clamp 426, as depicted in FIG. 4G1 or crimp tubing clamp 428, as depicted in FIG. 4G3.

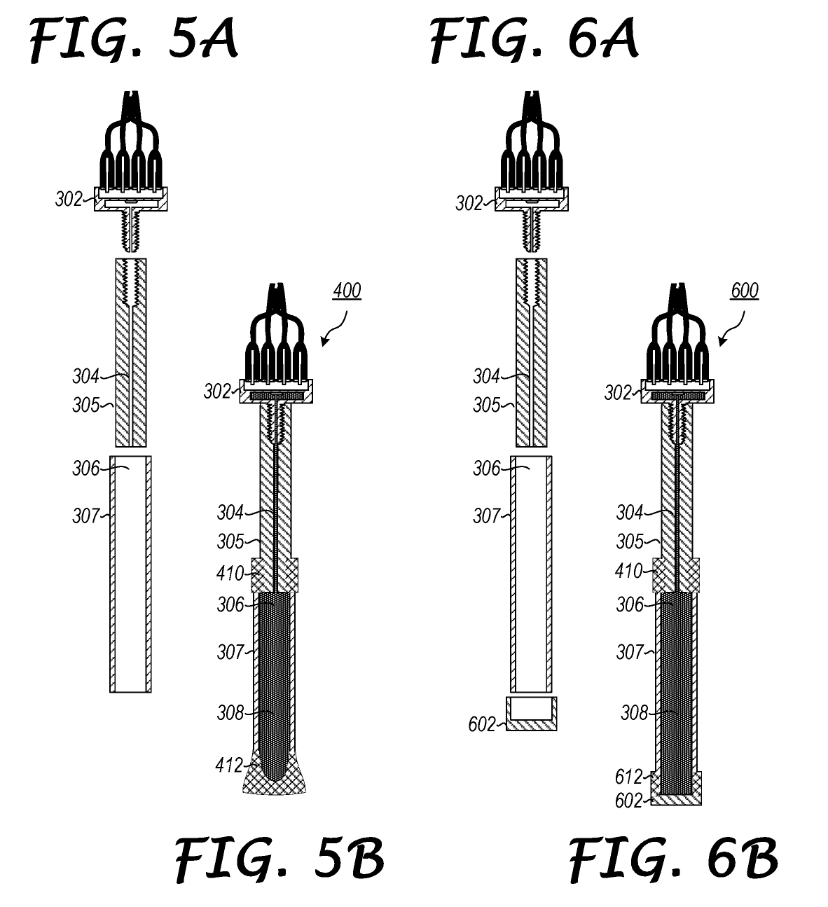

Generic low pressure sensor system 300 depicted in FIG. 3 can be modified in a variety of ways to accommodate operation environments and fabrication techniques, such as by fabricating pinched-end mandrel low pressure sensor 400 as shown in FIGS. 4A-4H, which is an extremely low cost fabrication technique. Other pressure bladder configurations are possible in addition to pinched-end version depicted in FIGS. 4H, 5A and 5B, such as capped-end mandrel low pressure sensor 600, wherein internal pressure chamber 306 is formed by terminating pressure bladder 307 with cap 602, see FIG. 6A and securing same to pressure bladder 307 by cap weld 612, see FIG. 6B. Alternatively, and as depicted in FIGS. 7A and 7B, internal pressure chamber 306 may be fabricated by terminating pressure bladder 307 with plug 702, see FIG. 7A and securing same to pressure bladder 307 by coupling weld 410, see FIG. 7B. Finally, closed-end FEP tubes are available, such as hemispheric-end pressure bladder 807. Utilizing these tubes, although expensive, allow operator to omit one welding operation in the fabrication process. Here, internal pressure chamber 306 may be fabricated using hemispheric-end pressure bladder 807 without further having to plug the pressure bladder, see FIGS. 8A and 8B.

Other modifications are possible to generic low pressure sensor system 300 without departing from the scope and intent of the present invention. For example and with regard to the previous examples, support mandrel 305 is secured to any of pressure bladders 307-707 by slipping support mandrel 305 into the pressure bladder a short distance and then FEP welding the adjacent surfaces of the pieces, as discussed above with regard to FIGS. 4B1 and 4B2. While this fabrication technique is quite economical, it creates sensor system bodies with two distinct external diameters, and furthermore, the larger diameter on the pressure bladder, makes it much more difficult to insert the low pressure sensor system into a compression fitting for mounting. An alternative is to use a longer pressure bladder (referred to hereinafter as a full-length pressure bladder), as seen on any of pressure mandrels 307-707. The entire length of support mandrel 305 is inserted into the full-length pressure bladder, thereby forming coaxial support mandrel 805. For example, coaxial support mandrel 805 comprising support mandrel 305 and the upper portion of hemispheric-end pressure bladder 807 (depicted as a full-length pressure bladder) is shown in low pressure sensor system 800, and also coaxial support mandrel 805 comprising support mandrel 905 and the upper portion of full-length pressure bladder 907 is shown in low pressure sensor system assembly 900 in FIGS. 8 and 9, respectively. Low pressure sensor system 800 differs from low pressure sensor system assembly 900 only by the closure methods, system assembly 800 utilizes a hemispheric-end pressure bladder 807, while system assembly 900 utilizes full-length pressure bladder 907 with pinched end closure weld 412. In either case, coaxial support mandrel 805 is formed by the coextensive portion of a full-length pressure bladder and a support mandrel. Coaxial support mandrel 805 is secured together with coupling welds 410 located, at least, at either ends of the support mandrel. In so doing, the exterior surfaces of low pressure sensor systems 800 and 900 have a continuous unified diameter bladder allowing for effortless insertion of the pressure bladder into compression fitting 922.

Generic low pressure sensor system 300 is almost infinitely configurable for measuring pressures in a variety of hazardous applications. For example, generic low pressure sensor system 300 may be configured for static pressure measurements, see any of sensor system assemblies 800, 1000, 1001, 1800 and 1900, for example, either externally, see sensor system assemblies 800, 900, 1800 and 1900, with only the pressure bladder exposed to the fluid medium, or fully submerged, see submersible pressure sensor system assemblies 1000 and 1001 in which the entire sensor system is immersed in the fluid medium. Submerged sensor systems can also be deployed for making dynamic measurements, such as by moving generic low pressure sensor system 300 through a tubing structure, see, for example, the discussion of the submerged low pressure sensor system assemblies associated with FIG. 17. Additionally, generic low pressure sensor system 300 is not confined to a particular type of pressure sensor, it can accommodate piezo-type pressure sensors, deflection-type pressure sensors or others. One advantage to using deflection-type pressure sensors is that the measurement range for the generic low pressure sensor system can be modified to fit a particular application by adjusting the size of the pressure bladder and selecting a deflection sensor with the appropriate pressure response range, see, for example, the discussions associated with FIGS. 12A, 12B, 13A-13C, 14A-14C, 15A, 15B, 16A and 16B.

With further regard to static pressure measurements, a common configuration for making static pressure measurements for generic low pressure sensor system 300 utilizes a compression fitting (or other pressure isolating device) for mounting the low pressure sensor system across a pressure barrier. Typically, the pressure bladder is immersed in the fluid medium and a compression fitting is secured about the support mandrel to pressure-isolate the pressure sensor from the fluid medium.

FIG. 9 is a cross-sectional diagram of low pressure sensor system assembly 900 (having an exposed pressure sensor and a coaxial support mandrel) mounted across a pressure isolation barrier in accordance with one exemplary embodiment of the present invention. This type of sensor assembly is designed to be attached to an existing port on a tank, pipe, tubing, etc. (usually at a threaded port using a threaded fitting, such as exemplary fitting 923). In practice, a low pressure sensor system used in this assembly could be any of generic low pressure sensor system 300 (depicted in FIG. 3), low pressure sensor system 400 (with a larger diameter pressure bladder) (depicted in FIG. 4), low pressure sensor system 600 (with cap), low pressure sensor system 700 (with plug) (depicted in FIGS. 6B and 7B, respectively) low pressure sensor system 800 (with full-length, hemispheric-end pressure bladder 807) (depicted in FIG. 8B) or others. As shown in the figure, the low pressure sensor system has full-length pressure bladder 907 terminated with a pinched end closure weld 412. Low pressure sensor 302 is isolated (distal) from hazardous fluid medium 309 (rather than being immersed within it (proximate) as will be discussed further below with regard to FIGS. 10A and 10B). As discussed above with regard to the discussion of low pressure sensor system 800 (with coaxial support mandrel 805 and full-length hemispheric-end pressure bladder 807) depicted in FIG. 8. As discussed above, by using a longer pressure bladder to create a coaxial support mandrel, the exterior cylindrically-shaped body is a uniform diameter from the sensor down. The uniform diameter allows for effortless insertion in to compression fitting 930. Compression fitting 930 is secured about the coaxial support mandrel 805 (i.e., about the upper portions both support mandrel 905 and full-length pressure bladder 907).

As depicted, compression fitting 930 cooperates with threaded collar 921 to secure continuous diameter low pressure sensor system into low pressure sensor system assembly 900. Threaded collar 921 may be fastened directly into a female fitting on a tank or pipe with full-length pressure bladder 907 extending into an interior cavity of a pipe, tank or other vessel, however, as the pressure bladder is highly susceptible to tears from moving fluid, suspended particles, and other forces. Therefore, optimally, full-length pressure bladder 907 does not extend into any interior cavities, but instead is offset away from the interior by, for example, using a threaded sub or collar 921 as an offset to protect the bladder from hydraulic forces or containment particles that might compromise it. Exemplary collar 921 is coupled between threaded couplers 930 and 923, and male pipe thread coupler 923 is further coupled to exemplary tee fitting 918, the piping system that conveys fluid medium 309. A similar configuration is possible for any container, tank, or tube having an open fitting for receiving threaded coupler 923.

Low pressure sensor system assembly 900, generally comprising only the components shown above compression fitting 930 and is assembled as a unitary assembly that can be threaded into any threaded sub, pin or other port as needed. Assembly starts at the cable end, with upper lock nut 934, protective pipe 940 and upper compression fitting 932 being slid over conductor tubing 916 thereby leaving conductors 917 exposed. Inner shrink tube 920, intermediate shrink tube 922 and outer shrink tube 924 are also slid over conductor tubing 916 and conductors 917. The connection pins on OTS low pressure sensor 302 are then electrically coupled to conductors 917 (as is optional thermistor 303, if present). Inner shrink tube 920, which may be an electrically insulating shrink tube or FEP, is moved across the connection pins and over conductor tubing 916 and heat-shrunk in place. Next, intermediate shrink tube 922 is moved over the body of OTS low pressure sensor 302, completely over inner shrink tube 920 and over conductor tubing 916. Intermediate shrink tube 922, which also may be either an electrically insulating shrink tube or FEP, is then heat-shrunk in place. Finally, outer shrink tube 924, which is an FEP-type of shrink tube, is moved over intermediate shrink tube 922 and OTS low pressure sensor 302 and positioned from conductor tubing 916 to coaxial support mandrel 805 (recall that pressure bladder 907 is mechanically coupled to support mandrel 905 by coupling weld 410). Outer shrink tube 924 is then heat-shrunk in place. After shrinking, outer shrink tube 924 fits tightly around both conductor tubing 916 and mandrel 905. Finally, the top end of outer shrink tube 924 is secured to conductor tubing 916 by coupling weld 410 and the lower end of outer shrink tube 924 is secured to coaxial support mandrel 805 by second coupling weld 410.

With OTS low pressure sensor 302 and coaxial support mandrel 805 both secured to conductor tubing 916, compression fitting 930 is lowered positioned on coaxial support mandrel 805 and secured. Protective pipe 940 (with upper compression fitting 932) is then moved across the sensor to a position with the lower end protective pipe 940 just above the outer tightening nut on lower compression fitting 930. The position of upper compression fitting 932 is then marked on conductor tubing 916. Protective pipe 940 is then moved up on conductor tubing 916 and away from upper compression fitting 932, which remains aligned with the mark. Upper compression fitting 932 is then secured to conductor tubing 916 at that position. Protective pipe 940 can then be moved back down over upper compression fitting 932 and secured in place using upper locking nut 934.

With protective pipe 940 locked in place and covering everything between the lower part of upper compression fitting 932 and the outer tightening nut on lower compression fitting 930, a closed cell, rigid cure spray foam 942, can be injected between protective pipe 940 and allowed to cure. Low pressure sensor system assembly 900 is then complete, but care should be taken as full-length pressure bladder 907 extends beyond lower compression fitting 930 and is unprotected.

Alternative to using protective pipe 940, one off-the-shelf solution for increasing structural rigidity is by using a cable protector (not shown) that couples to compression fittings 932 and 930 or other rigid structure, and encases OTS low pressure sensor 302 with conductors 917. This cable protector can also be filled with rigid cure spray foam 942 as desired.

Continuous diameter low pressure sensor system assembly 900 may be used anywhere an external port or fitting provides access to an interior chamber or cavity holding fluid medium such as pipes, tubing, casing, various locations on storage tanks as shown in FIG. 11A, various vertical levels corresponding to specie extraction points as shown in FIG. 11B, on chemical injection tanks as shown in FIG. 11C, and at various locations on truck, rail and marine tanks, as shown in FIG. 11D. However, some applications require pressures to be taken at or near the bottom of a storage or separator tank, or other type of reservoir, such as for monitoring the maximum hydrostatic pressure of a tank.

In accordance with another exemplary embodiment of the present invention, utilizing a continuous diameter pressure bladder has other advantages not discussed above. These continuous diameter pressure bladders, such as continuous diameter variant of a hemispheric-nosed, generic low pressure sensor assembly 800 and low pressure sensor system assembly 900 depicted in FIGS. 8A, 8B and 9, respectively, utilize a full length pressure bladder that completely encapsulates the support mandrel. Therefore, the support mandrel need not be comprised of an expensive material that is resistant to hazardous materials, such as FEP, but may instead be fabricated from any type of tubing that will hydraulically couple to the pressure sensor fitting, and does not react with the measurement fluid. Furthermore, because the support mandrel and pressure bladder are joined together above the pressure sensor fitting, the support mandrel and pressure bladder need not be welded together, but may instead be hydraulically coupled using the same tubing clamp used to secure the pressure senor, such as a spring clamp, a spiral wire nut tubing clamp or a crimp tubing clamp.

FIGS. 10A and 10B are cross-sectional diagrams of submersible low pressure sensor system assemblies for immersion in hazardous fluid mediums in accordance with various exemplary embodiments of the present invention. These applications often involve the need for monitoring the hydrostatic pressure in legacy storage and chemical tanks and the like that are not fitted with (or certified for) ports near the base of the tank (near the bottom of the fluid in the tank). Many of those tanks have only larger diameter ports or hatches on their roofs sealed with blanking flanges. Hydrostatic pressures for those legacy tanks may be monitored by lowering a submersible low pressure gauge through rooftop port to the bottom of the tank. The sensor rests at or near the tank's bottom and its cabling is hung off at the rooftop port. Usually, the banking flange is replaced or modified with a b\packing gland that secures the sensor's cabling.

As depicted in the drawing figures, submersible low pressure sensor system assemblies 1000 and 1001 utilize low pressure sensor system 300, but may be fitted with any of the low pressure sensor system embodiments as discussed above. The primary difference between low pressure sensor system assembly 1000 and low pressure sensor system assembly 1001 is that assembly 1000 utilized an FEP shrink tube to protect the assembly, while assembly 1001 utilized a rigid tube.

The aim here is to insulate OTS low pressure sensor 302 and electrical conductors 1017 from fluid medium, which may be hazardous, even while being fully immersed in fluid medium 309. A further aim is to protect the system's pressure bladder from being damaged, even while being fully submerged at or near the bottom of a tank or other vessel. Low pressure sensor system assembly 1000 is similar in many regards to low pressure sensor system assembly 900, discussed immediately above, however, low pressure sensor system assembly 1000 uses FEP tubing to insulate the submerged sensor that is proximate to the fluid medium, rather than using a compression fitting as pressure interface to isolate the distal pressure sensor from the fluid medium, as can be appreciated as low pressure sensor system assembly 900 in FIG. 9 above.

In practice, a low pressure sensor system used in this assembly could be any of sensor systems discussed above, but as depicted in the figure, the low pressure sensor system utilizes coaxial support mandrel 805 with full-length pressure bladder 1007 that is terminated with a pinched end closure weld 412 similarly to that described in FIG. 9 above. The connection pins on OTS low pressure sensor 302 are electrically coupled to conductors 1017 (as is optional thermistor 303, if present). Inner shrink tube 1020, which is one of an electrical insulating or FEP shrink tube, is moved across the connection pins and over conductor tubing 1016 and heat-shrunk in place. Next, ballast is added to the sensor assembly in the form of one or more ballast weight 1055, which are disposed around the upper end of inner shrink tube 1020 and/or conductor tubing 1016 and then secured. Ballast weight 1055 may be comprised of a lead bar that is twisted over the shrink tube and conductor tubing (if non-reactive material is desired, the lead may be substituted for stainless steel, glass or high density ceramic rings).

Next, intermediate shrink tube 1022 is moved over the body of OTS low pressure sensor 302, ballast weights 1055, and completely over inner shrink tube 1020 from mandrel 1005 to conductor tubing 1016. Intermediate shrink tube 1022, which also may be insulating type of shrink tube, or alternatively FEP, is then heat-shrunk in place (which also secures ballast weights 1055 in place). Next, isolating tube 1024, which is an FEP-type of tube and might also be an FEP-type of shrink tube as discussed above, is moved over intermediate shrink tube 1022 and OTS low pressure sensor 302, from conductor tubing 1016 to axial support mandrel 805 and then heat-shrunk in place. After which, the heat-shrunk intermediate shrink tube 1022 is mechanically coupled to both mandrel 1005 and conductor tubing 1016, optionally, but not necessarily, by FEP-welding a pair of coupling welds 410. Here it should be mentioned that most protective tubing that is not exposed to the fluid medium, including hazardous mediums, are mechanically secured in-place, usually by shrinking the tubing in-place. Typically, this inner tubing not welded in-place, but may be. On the other hand, the exterior tubing that does come in contact with the fluid medium, must be mechanically fasten in-place securely, typically by welding the end or ends in-place. One of ordinary skill in the art would readily understand that the mechanical fastening technique employed is dependent on the type of isolation desired. If the fastening requires a leak-free connection, then welding, clamping or some other water-proofing connection is necessary. However, if what is needed is merely a protective isolation layer, for electrical isolation for instance, than shrinking tubing in-place may be a more economical solution.

At this point, the assembly is functional and may be immersed in fluid medium 309, however, full-length pressure bladder 1007 is exposed and would likely be damaged by fluid flow and/or contaminants in the fluid medium. In order to protect pressure bladder 1007, protective FEP shrink tube 1026 is positioned from conductor tubing 1016 and extending beyond the end of full-length pressure bladder 1007, thereby covering the entire sensor assembly including the pressure bladder. Protective FEP shrink tube 1026 is then mechanically coupled to conductor tubing 1016 by heat shrinking it in place and with coupling weld 410.

One benefit of using a shrinkable tubing is that the tubing shrinks and usually adheres circumferentially to an inner tube. The two tubes can then be fully joined together with an FEP weld. Often, however, a gap exists between an inner and outer tubing because the outer tubing does not fit tightly about the inner. There the solution is to draw the outer tube tight around the inner tube by forming a pair of ear flaps on either side of the tube that takes up the extra outer tube. FIG. 10C depicts both a longitudinal cross-sectional view and a perpendicular cross-sectional view of the ear welds on coupling weld 1050. The ears flaps can then be FEP welded, along with the outer tube to the inner tubing, see coupling weld 1050 (ear weld) depicted in FIG. 10C.

FIG. 10B is a cross-sectional diagram of submersible pressure sensor system assembly for immersion in hazardous fluid mediums wherein the pressure bladder is protected by a rigid tube, rather than in a shrinkable FEP tube as shown in submersible pressure sensor system assembly 1000 on FIG. 10A. Submersible low pressure sensor system assembly 1001 is a simplified version of assembly 1000 shown in FIG. 10A, depicted here without ballast weights or any of the inner or intermediate shrink tubing depicted in the previous figure. One of ordinary skill in the art would readily understand that these features, and more, could be included in the assembly without departing from the scope or intent of the present invention. In accordance with this exemplary embodiment of the present invention, a rigid fluoropolymer tube is secured at one end to the sensor system's mandrel and at the other end to the conductor tubing by way of annular stand-offs.

Upper annular stand-off 1010A and lower annular stand-off 1010B may be die-cut from fluoropolymer (FEP) sheet stock, or alternatively, fabricated from a continuous strip of sheet fluoropolymer (typically FEP). The latter fabrication method of annular stand-offs 1010A and 10108 is depicted in FIG. 10D. Annular stand-offs 1010A and 10108 are fabricated by winding the strip FEP around the sensor assembly and continuously FEP welded during winding. Notice that the strip is FEP welded 404 together simultaneous with winding the FEP strip onto conductor tubing 1016. Lower annular stand-off 1010B is fabricated by simultaneously winding and FEP welding 404 a strip of FEP onto mandrel 305. Optionally, the FEP strip for upper annular stand-off 1010A may begin with a wide strip near conductor tubing 1016 and then narrows as the standoff becomes taller. This forms a “bullnose” shape that enables the sensor system assembly to be easily drawn through pipe or vascular tubing (see the discussion associated with FIG. 17). Once the annular standoffs are welded in place, the rigid FEP tubing 1012 is slipped over upper annular stand-off 1010A and lower annular stand-off 1010B. Rigid FEP tubing 1012 is then welded in place on the annular standoffs.

One interesting feature of an exemplary embodiment of the presently described sensor system assemblies, is that the measurement range of the pressure reading can be altered merely by adjusting the length of the pressure bladder that is exposed to the fluid medium. The measurement range refers to the resolution of the measurement readings, for example, some pressure sensors may be accurate to the tenth psi (0.1 psi), others to the hundredths psi (0.01 psi). Sensors with the capability of reading greater resolution are, as may be expected, far more expensive than those capable of reading lower resolutions.

The principle of altering the measurement range of the pressure reading works by using a deflection-type pressure sensor, such as deflection-type pressure sensor 100 discussed above with regard to FIG. 1. Piezo-type pressure sensors, such as piezo-type pressure sensor 200 discussed above with regard to FIG. 2, operate on a different principle than deflection-type pressure sensors and therefore are not suitable for use in range altering, as will be appreciated from the discussion directly below. FIGS. 12A and 12B are conceptual diagrams that graphically illustrate the operating principle behind a piezo-type pressure sensor. These sensors operate on a compression mode, in that, as force is increases (that is, the pressure of the fluid medium increases), the measurement fluid does not move, but it is compressed in place, resulting in its internal pressure increasing. The electrical properties of the piezo material (piezoelectric die 206 depicted in FIG. 2) change with pressure and those properties are measured, resulting in the pressure reading (psig) from the sensor.

Deflection-type pressure sensors, such as deflection-type sensor 100 discussed above with regard to FIG. 1, operate on a completely different principle. These sensors require the pressurized fluid medium to move, slightly, in order to cause a measurement membrane to deflect. Such as by causing diaphragm 104 to deflect within measurement chamber 105 for deflection-type sensor 100 as briefly discussed above with regard to FIG. 1.

Deflection-type pressure sensors operate on a mechanical deflection mode, in that the force with the pressurized fluid medium increases, then the force against the measurement membrane increases (that is the pressure of the fluid medium increases), resulting in the measurement membrane deflecting a distance that is related to the increased force. That deflection distance is a function of primarily two factors, the biasing force of the membrane and the size (area) of the measurement membrane. The biasing force is the internal resistance within the measurement membrane, for example diaphragm 104 resists the force within the measurement fluid. The greater the biasing force, the less measurement membrane will deflect. Also, larger measurement membranes will deflect more than smaller ones with the same force being applied.

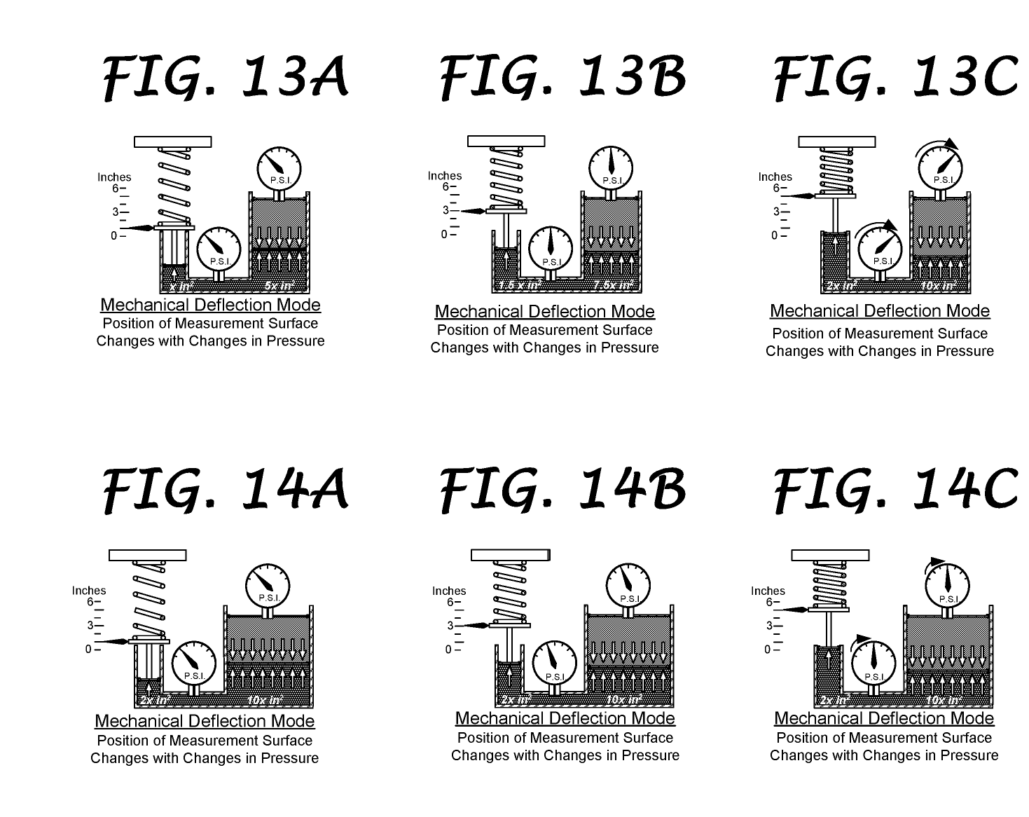

It is not possible to alter the measurement range of a deflection-type pressure sensor directly, as may be better appreciated from a discussion of the following. FIGS. 13A, 13B and 13C are conceptual diagrams that graphically illustrate the operating principle of a deflection-type system. As depicted in the exemplary figures, this principle is best conceptualized as a closed, two piston hydraulic system, when the primary piston receives a force, it moves slightly. That movement creates a force that is hydraulically transferred to a secondary piston, causing the secondary piston to move a distance that is proportional to the distance the primary piston moved. The proportional distance is related to the ratio of the area of the first piston to the area of the second piston.

An interesting feature is that by adjusting the ratio of the areas of the primary piston to the secondary piston, the proportional distance moved by the second piston can be altered. Conceptually, this is can be visualized by comparing the responses of the closed hydraulic piston system in FIGS. 14A, 14B and 14C, with those discussed above with regard to FIGS. 13A, 13B and 13C. Notice that the ratio of the primary piston to the secondary piston in FIGS. 14A, 14B and 14C is much greater than the ratios on the pistons represented in FIGS. 13A, 13B and 13C, that is, the primary pistons in FIGS. 14A, 14B and 14C have a larger area than those represented in FIGS. 13A, 13B and 13C. Larger area ratios of primary to secondary pistons will result in larger proportional distance movements of the secondary piston. This can be appreciated by comparing the deflection of the secondary piston in FIGS. 14A, 14B and 14C to FIGS. 13A, 13B and 13C. In other words, the proportional distance movement for the secondary piston of systems in FIGS. 14A, 14B and 14C has been enhanced over the secondary piston of the systems represented in FIGS. 13A, 13B and 13C. When this feature is to be applied to pressure sensor systems, the measurement range of the pressures sensor systems can be increased without using a more precise and expensive pressure sensor.

A typical deflection-type pressure sensor does not completely correlate to the conceptual illustration depicted in FIGS. 13A, 13B and 13C because, at best, it utilizes only a single piston (the secondary piston in closed, two piston hydraulic system). Conceptually, a deflection-type sensor does not approximate closed, two piston hydraulic system. Hence, the amount of deflection of the measurement membrane is based only on the biasing force over the area of the measurement membrane. However, closer attention to the presently described generic low pressure sensor system 300 reveals that it is more similarly representative the conceptual two-piston closed hydraulic system illustrated in FIGS. 13A, 13B and 13C, with the exception of the piezo-type pressure sensor. Since the piezo-type pressure sensor does not utilize a deflection membrane, conceptually, it is missing the second piston. This is remedied by substituting a typical deflection-type pressure sensor for the piezo-type pressure sensor.

Turning to FIGS. 15A and 15B, deflection-type pressure sensor system 1500 is depicted as being virtually identical to generic low pressure sensor system 300 described above with regard to FIG. 3, with the exception of substituting deflection-type pressure sensor 100 for the piezo-type pressure sensor 200 utilizing deflection-type pressure sensor 100, rather than piezo-type pressure sensor 200. Deflection-type pressure sensor system 1500 may be conceptually described as having an equivalent primary piston (pressure bladder 307) and an equivalent secondary piston (diaphragm 104). Therefore, pressure from the fluid medium causes pressure bladder 307 to deform, resulting in a pressure buildup in measurement fluid and a force on diaphragm 104, causing it to move or deflect a certain amount.

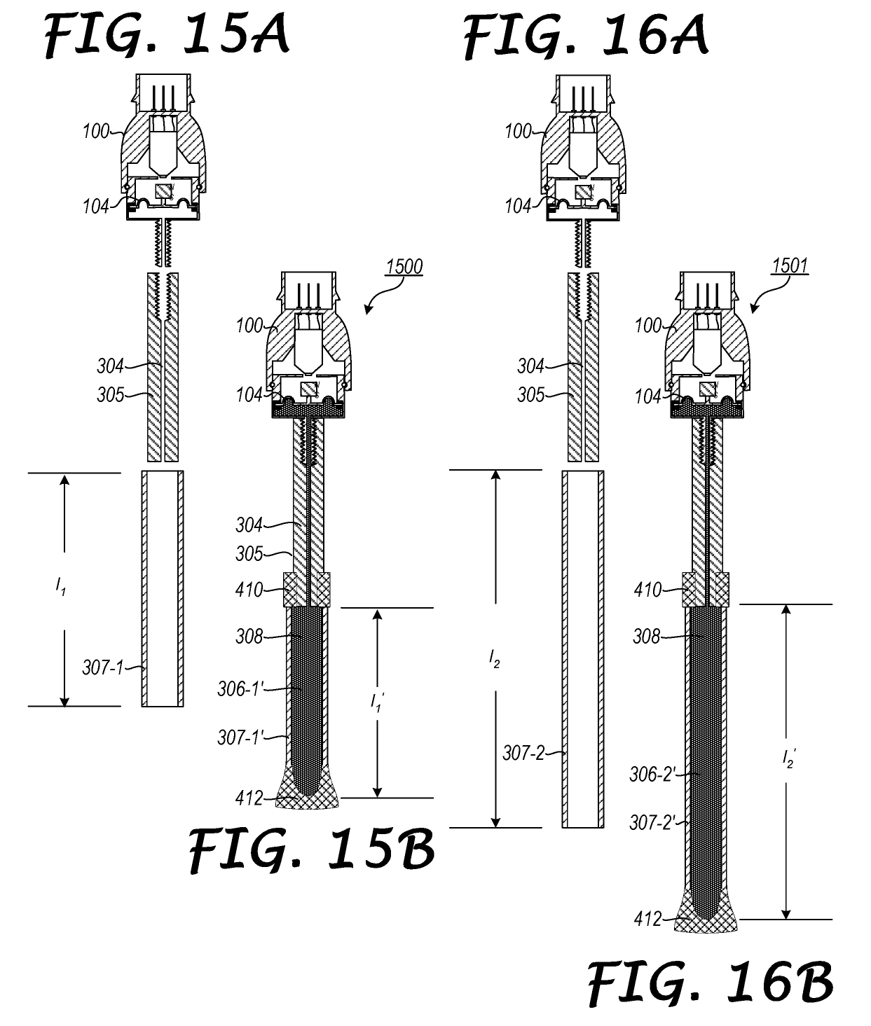

This enhancement of measurement range can be achieved for the present invention merely by adjusting the surface area of the pressure bladder exposed to the fluid medium, while using a deflection-type pressure sensor system, such as deflection-type pressure sensor systems 1500 and 1501, respectively, shown in FIGS. 15A, 15B, 16A and 16B. Notice that pressure bladder 307-1 depicted in deflection-type pressure sensor systems 1500 has an equivalent length l₁′, but pressure bladder 307-2 depicted in deflection-type pressure sensor systems 1501 has a longer bladder, having an equivalent length, l₂′. The increased area exposed to the fluid medium of pressure bladder 307-2 over pressure bladder 307-1 will result in an increase in the measurement range of deflection-type pressure sensor systems 1501.

In order to realize the benefit of the enhanced measurement range, it should be understood that the force at diaphragm 104 of deflection-type pressure sensor systems 1501 is greater than for deflection-type pressure sensor systems 1500. Therefore, deflection-type pressure sensor systems 1501 will read higher (psig) than the actual pressure of the fluid. Hence, for most applications, it is necessary to select deflection-type pressure sensor 100 with a higher (and wider) pressure range in order to accommodate the higher and wider pressure readings (psig). For example, if by modifying (increasing) the size of the pressure bladder the ratio is doubled, than it might be expected that the deflection of diaphragm 104 might increase a correspondingly amount (doubling the range and scale of the readings (psig)) and, therefore, might exceed the higher end operating range of the particular pressure sensor. Hence, a deflection-type pressure sensor with twice the operating range of the original sensor would be an appropriate selection. For example, a 0 psi-40 psi range pressure sensor might be substituted for a pressure sensor having a 0 psi-20 psi pressure range to accommodate the increase in pressure readings (psig). Importantly, when this replacement pressure sensor is disposed within the present invention, such as within deflection-type pressure sensor systems 1501, the readings received from that system must be reduced or scaled proportional in order to realize the true enhanced measurement range. For example, if as in the above example the measurement range is doubled, then the reading from the substitution sensor system should be decreased by the same proportion to be accurate, or by half. Hence, the resulting reading will be accurate, but twice as precise, that is it will have twice the pressure resolution.

In accordance with still another exemplary embodiment of the present invention, generic low pressure sensor system 300 can be deployed in a dynamic configuration, not just static. Pipes, tubing, vascular and arterial structures all have the potential for collapsing, bending, constricting, or accumulating deposits of scale, sludge, plaque, and other materials that affect the flow of the fluid medium. While many inspection techniques are available, sonar, ultrasound, video, radar, gauging pigs, etc., most of these options are expensive and/or have a fairly limited use in a narrow range of fluid types, or some other detriment to the conveyance system.

One economical solution for evaluating the interior condition of a vascular system is by using generic low pressure sensor system 300 to map the flow pressures throughout the line. FIG. 17 is a cross-sectional diagram of generic low pressure sensor system 300 in a dynamic configuration by using collapsible gauging pig 1704 for inspecting the condition of the interior walls of a vascular system in accordance with one exemplary embodiment of the present invention.

Tubing/vascular structure 1702 contains various defects to the interior walls, including various types of contaminant build-ups 1712 and wall thickening and kinks 1713, each that result in a reduction of flow of fluid medium 1720. Tubing/vascular structure 1702 may be organic or inorganic, if organic, the physical components represented in the accompany figures may be greatly miniaturized. Here, submergible low pressure sensor system assembly 1001 (see FIG. 10B) is pulled through tubing structure 1702 by tubing tether 1716. Submergible low pressure sensor system assembly 1001 generally comprises generic low pressure sensor system 300 and collapsible gauging pig 1704 coupled together on tubing tether 1716, which contains conductors 1717 that terminate at pressure monitoring equipment (not shown). As submergible low pressure sensor system assembly 1001 is pulled through tubing structure 1702 containing fluid medium 1720, collapsible gauging pig 1704 reduces the annular path for fluid medium 1720, thereby increasing the fluid pressure proximate submergible low pressure sensor system assembly 1001. The dynamic pressures observed by generic low pressure sensor system 300 are inversely proportional to the annular clearance between collapsible gauging pig 1704 and the interior of tubing structure 1702. Therefore, as gauging pig 1704 passes defects on the interior walls, such as build-ups 1712 and/or wall thickening 1713, the fluid pressures observed by generic low pressure sensor system 300 increase, and their locations within tubing structure 1702 can be noted for further evaluation and/or some other remedial action. Importantly, the defects remain unaffected by the mapping process until the operator determines the type and scope of remedial action to be taken. Once the remediation type has been determined, submergible low pressure sensor system assembly 1001 can then be coupled to the repair tool to identify the precise location of the defect in tubing structure 1702 to be repaired using the tool.

As mentioned elsewhere above, the present invention provides as highly economical alternative to low pressure sensors designed to operate in hazardous fluid mediums. This economy is achieved by utilizing an economical, off-the-shelf, non-hazardous rated pressure sensors and then insulating the OTS sensor from the hazardous fluid mediums using the presently described low pressure sensor system. It should be mentioned that if the insulation system fails and hazardous fluid reaches the pressure sensor, it is likely that the hazardous fluid will leak through the sensor. With regard to prior art sensor 200 depicted in FIG. 2, case 202, which forms the barbed port, provides virtually no protection against hazardous material. In fact, one manufacturer cautions that the case material is slightly reactive with fluids as inert as demineralized water. Therefore, special precautions should be considered when using these sensors. Consequently, directly below other exemplary embodiments of the present invention are disclosed that provide addition protection from exposure to hazardous mediums.

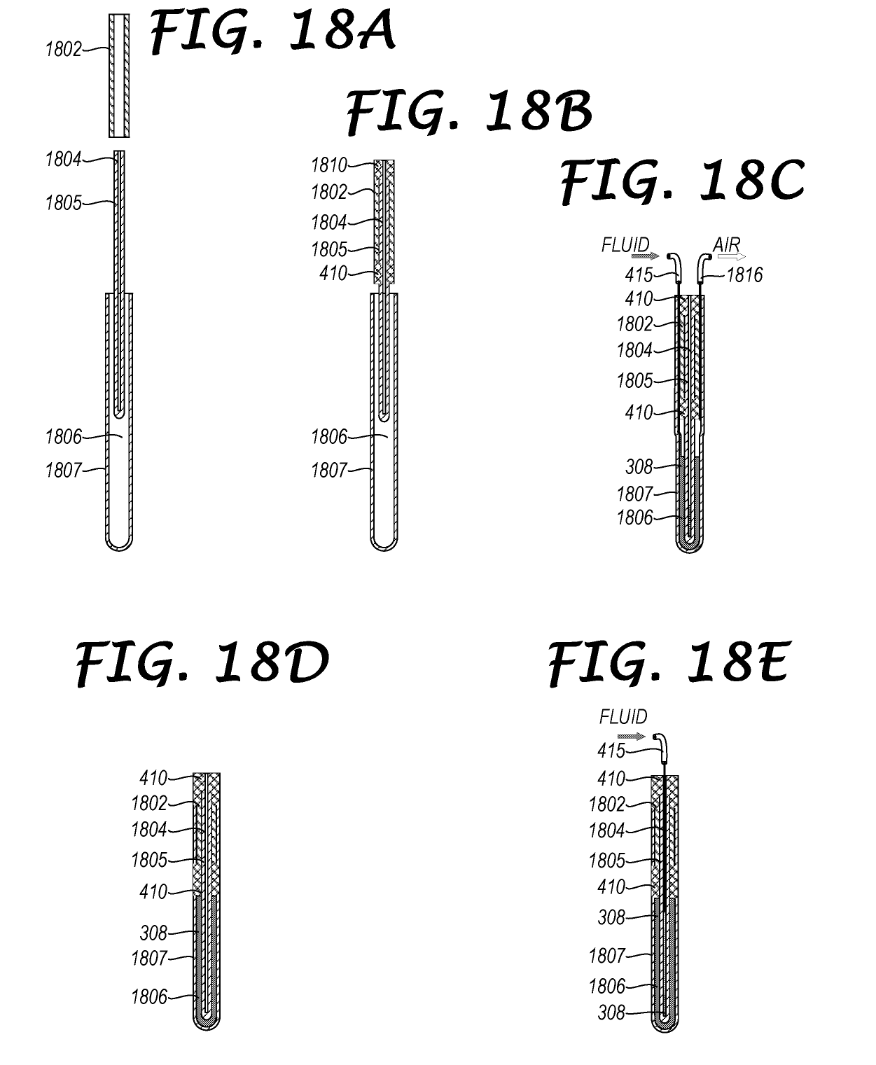

FIGS. 18A-18F illustrate an exemplary fabrication process for modifying generic low pressure sensor system 300 with secondary pressure bladder 1805 (and secondary interior chamber 1804) disposed inside primary interior chamber 1806, of primary pressure bladder 1807, see double bladder low pressure sensor system 1800 in FIG. 18F. Low pressure sensor system 1800 is similar to generic low pressure sensor system 300 except that low pressure sensor system 1800 provides an added measure of protection by way of an additional FEP barrier between OTS low pressure sensor 302 and the fluid medium. The body of low pressure sensor system 1800 is formed by three separate components, rather than just two with regard to generic low pressure sensor system 300. These components include primary pressure bladder 1807, secondary pressure bladder 1805 and annular sleeve 1802, see FIG. 18A. Initially, annular sleeve 1802 is slipped around the secondary pressure bladder 1805 and welds 1810 are formed across annular sleeve 1802 and secondary pressure bladder 1805 (at least at the upper and lower extents of the sleeve), see FIG. 18B. Next, secondary pressure bladder 1805 (with welded annular sleeve 1802) is slipped into primary interior chamber 1806 of primary pressure bladder 1807, see FIG. 18C. At this point, primary interior chamber 1806 is filled with measurement fluid 308 using injection tube 415 which is inserted into the air-tight seal between primary pressure bladder 1807 and annular sleeve 1802 (a second tube, air escape tube 1816) is positioned with its opened end approximately parallel to the lower end of annular sleeve 1802, thereby providing a path for air trapped within interior chamber 1806 to escape. Next, welds 1810 are formed between annular sleeve 1802 (with secondary pressure bladder 1805 welded therein) and primary pressure bladder 1807, again, at least at the uppermost and lowermost contact areas between annular sleeve 1802 and primary pressure bladder 1807, see FIG. 18D. Finally, secondary interior chamber 1804 is filled with measurement fluid 308 using injection tube 415, see FIG. 18E.

Double bladder low pressure sensor system 1800 is depicted in FIG. 18F with OTS low pressure sensor 302 coupled to exemplary compression fitting 315 over a fluid medium having a pressure, p₁. External pressure, p₁, is communicated across primary pressure bladder 1807 and into measurement fluid 308 within primary chamber 1806, but then the external pressure, p₁, is communicated across secondary pressure bladder 1805 and into measurement fluid 308 within secondary chamber 1804 and into OTS low pressure sensor 302. More importantly, should primary pressure bladder 1807 fail, for any reason, OTS low pressure sensor 302 is still protected from the hazardous fluid by secondary pressure bladder 1805. Also, any of the separate embodiments discussed previously can be modified to accommodate a secondary pressure bladder.

Double bladder low pressure sensor system 1800 provides additional protection between OTS low pressure sensor 302 and a pressurized fluid medium, however, it does not prevent hazardous materials from flooding past OTS low pressure sensor 302 in the event of a catastrophic failure.

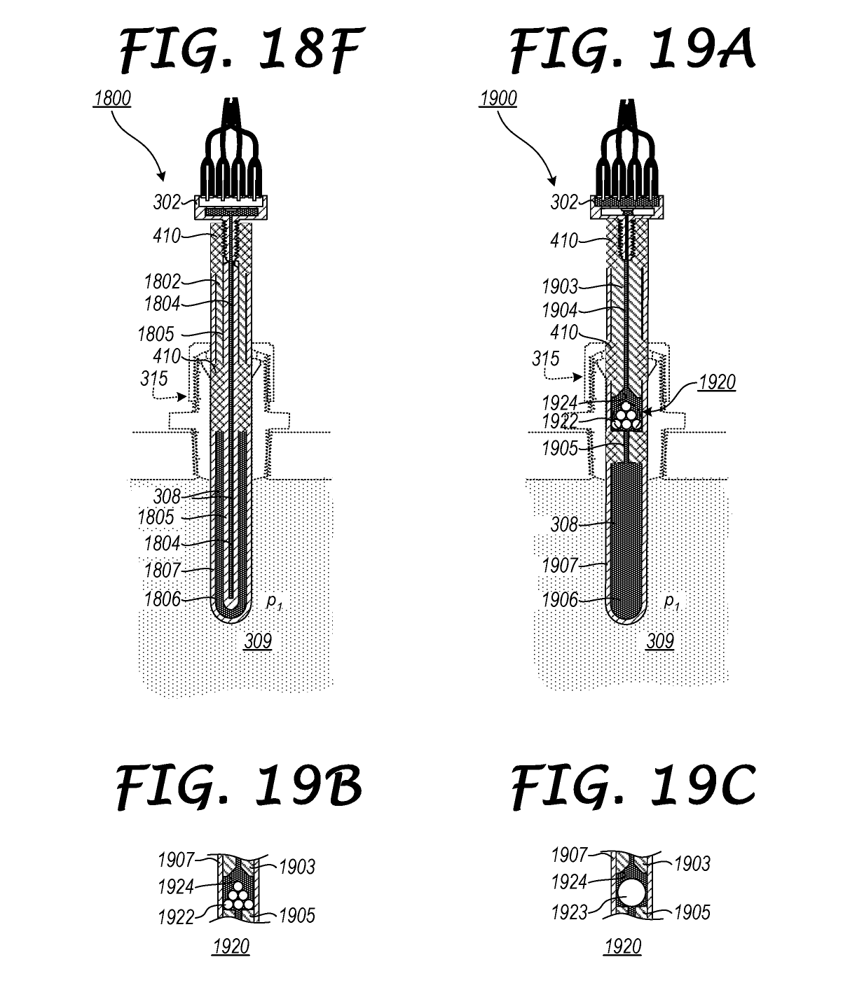

Flow control low pressure sensor system 1900 is depicted in FIG. 19A, on the other hand, seals unchecked fluid flow across the support mandrel by using sealing balls in accordance with exemplary embodiments of the present invention. In the event of a catastrophic failure, hazardous material will reach OTS low pressure sensor 302 and compromised its case, causing an atmospheric leak of the material through the sensor. Flow control low pressure sensor system 1900 mitigates the uncontrolled release of hazardous material by disposing flow control valve 1920 in the low pressure sensor system, usually within the mandrel section of the system. Essentially, flow control valve 1920 is formed within the mandrel, by dividing the mandrel into two sections, lower section 1905 and upper section 1903. Capillary channel 1904 traverses both the upper and lower sections, however, capillary channel 1904 terminates at the lower end of upper section 1903 as conical-shaped sealing surface 1924 in the upper extent of flow control valve 1920. Conical-shaped sealing surface 1924 provides a cooperating surface for receiving and engaging one of sealing balls 1922/1923 in the event of fluid movement within capillary channel 1904. Exemplary sealing balls 1922/1923 are fluoropolymer balls having a diameter sufficient to engage conical-shaped sealing surface 1924 and prevent the fluid medium from flowing to OTS low pressure sensor 302.

Flow control low pressure sensor system 1900 utilizing flow control valve 1920 should be oriented above horizontal and ideally near vertical to avoid sealing balls 1922/1923 inadvertently sealing off capillary channel 1904, even in a no-flow condition. Ideally, sealing balls 1922/1923 in flow control valve 1920 rest away from conical-shaped sealing surface 1924 and near the lower surface of flow control valve 1920. Sealing balls 1922/1923 should have a density much greater than measurement fluid 308, but at least one and a half times (×1.5) the density of the fluid medium. Exemplary fluoropolymer, such as solid PTFE balls, have an exemplary density of between 2.03 gm/cm and 2.18 gm/cm depending on the source and grade of the PTFE balls. Hollow balls that are available have gross densities less than 2.03 gm/cm. Flow control valve 1920 may be configured with multiple sealing balls 1922, see FIG. 19B. Using many, smaller sealing balls allows some movement of measurement fluid 308 without one of the balls sealing off flow control valve 1920, and without interfering with the pressure measurements. However, in the case of a leak, some hazardous material will escape before one of the many sealing balls 1922 finally seals flow control valve 1920. Using one larger sealing ball 1923, see FIG. 19C, offers a faster sealing action in the event of fluid movement. The diameter of larger sealing ball 1923 does not allow for much fluid clearance, so any fluid movement within flow control valve 1920 will likely move larger sealing ball 1923 into the sealing position at sealing surface 1924.

Although not discussed in great detail, any embodiment of generic low pressure sensor system 300 may be electrically coupled to a monitoring unit, such as a computer, smart device, tablet, or other computational device. Basically, the monitoring unit delivers power to generic low pressure sensor system 300 and receives voltage or other sensor signals and in response communicates that data to data/processing remote centers, clouds, or portable devices. Ideally, information gathered from t h e monitoring unit, whether remote, local, or mobile sources, makes its way to a web application in the cloud, such as the Advantis Web Application also available from Advantis, L.L.C., which can be viewed by computer and smart phone. These devices may then process the data locally and/or compare the data to alarm thresholds (or a predetermined pressure range) and the like. In accordance with exemplary embodiments of the present invention, the monitoring unit may support a variety of different priority cry-out alarms. The purpose of a cry-out alarm is to alert someone that a pressure alarm threshold has been crossed and a warning condition exists. Whenever a warning condition is detected (such as the internal pressure of the fluid medium is outside a predetermined pressure range for the fluid medium), the monitoring unit activates a cry-out alarm. Also, the monitoring unit may utilize electronic (digital) cry-out means in the event of a warning condition, such as sending an email message, text message, pager message, voice message, web app message, mobile app message or other type of electronic message to designated recipient(s) at a predetermined electronic address(es). In either case, the monitoring unit typically determines whether an alarm threshold(s) has(ve) been exceeded, rather than the threshold determination being made at a remote site.

The exemplary embodiments described above were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention as embodied in the claims below is not intended to be limited to the embodiment shown, but is to be accorded the widest scope consistent with the principles and features described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A pressure sensor system for monitoring fluid pressure of a hazardous material, the pressure sensor system comprising:
a pressure sensor, comprising:
a housing case comprising:
an exterior surface;
an interior surface; and
a measurement chamber formed by at least a portion of the interior surface;
a plurality of electrical connection pins traversing the housing case, each of the plurality of electrical connection pins having a portion exposed through the housing case;
a sensor transducer for converting fluid pressure to electrical signals proportional to a level of the fluid pressure, the sensor transducer being disposed at least partially within the measurement chamber of the housing case and being electrically coupled to at least one of the plurality of electrical connection pins; and
a pressure fitting disposed along an exterior surface of the housing case and having a port traversing the exterior surface into the measurement chamber;
a pressure bladder for insulating the pressure sensor from a fluid medium external to the pressure bladder while simultaneously conducting pressure from the external fluid medium, the pressure bladder being comprised of chemically resistant material of one of a fluoropolymer, fluorinated ethylene propylene (FEP) and perfluoroalkoxy polymer (PFA), the pressure bladder comprising:
an exterior surface;
an interior surface;
a first opening on a first end on the exterior surface;
a second end on the exterior surface; and
an interior chamber formed by the interior surface of the pressure bladder and having the first opening on the first end connected to the measurement chamber of the pressure sensor via the pressure fitting; and
a measurement fluid for translating fluid pressure, the measurement fluid being disposed within the measurement chamber of the housing case and within the interior chamber of the pressure bladder.

2. The pressure sensor system recited in claim 1 above, further comprises:
a support mandrel for providing structural and being coupled between the pressure fitting of the case housing and the pressure bladder, the support mandrel comprises:
an exterior surface;
an interior surface;
a first opening on a first end on the exterior surface;
a second opening on a second end on the exterior surface; and
an interior channel with measurement fluid disposed within, the interior channel being formed by the interior surface and being connected between the first opening and the second opening.

3. The pressure sensor system recited in claim 2 above, wherein the support mandrel being comprised of one of a fluoropolymer, FEP and PFA, the pressure sensor system further comprises:
a polymer weld between the exterior surface of the support mandrel and the interior surface of the pressure bladder.

4. The pressure sensor system recited in claim 3 above, further comprises:
a thermistor for measuring temperature.

5. The pressure sensor system recited in claim 4 above, wherein the pressure sensor system further comprises:
a conductor tubing, wherein the conductor tubing being comprised of one of a fluoropolymer, FEP and PFA; and
a plurality of electrical conductors partially disposed within the tubing conductor for conducting electrical power and electrical signals between the pressure sensor and a control device, at least one of the plurality of electrical conductors being electrically coupled to at least one of the plurality of electrical connection pins of the pressure sensor.

6. The pressure sensor system recited in claim 5 above, wherein the pressure sensor system further comprises:
an isolation tube for isolating the pressure sensor from the external fluid medium and being comprised one of a fluoropolymer, FEP and PFA, the isolation tube comprises:
a first end, wherein the isolation tube is mechanically coupled to the conductor tubing proximate to the first end.

7. The pressure sensor system recited in claim 6 above, wherein the pressure sensor system further comprises:
rigid spray foam, wherein the rigid spray foam is disposed within the isolation tube.

8. The pressure sensor system recited in claim 6 above, wherein the isolation tube further comprises:
a second end, wherein the isolation tube is mechanically coupled to the support mandrel proximate to the second end.

9. The pressure sensor system recited in claim 8 above, wherein the isolation tube is polymer welded between the exterior surface of the conductor tubing and the interior surface of the isolation tube proximate to the first end and the isolation tube is polymer welded between the exterior surface of the support mandrel and the interior surface of the isolation tube proximate to the second end.

10. The pressure sensor system recited in claim 5 above, wherein the pressure sensor system further comprises:
at least one shrink tube positioned over one of the a plurality of electrical connection pins, the housing case and the pressure sensor.

11. The pressure sensor system recited in claim 9 above, wherein the pressure sensor system further comprises:
a ballast weight coupled to one of the plurality of electrical conductors, isolation tube and the support mandrel.

12. The pressure sensor system recited in claim 9 above, wherein the pressure sensor system further comprises:
a protective tube for protecting the pressure sensor and support bladder and being comprised one of a fluoropolymer, FEP and PFA, the isolation tube comprises:
a tube body, wherein the pressure bladder is disposed within the tube body; and;
a first end, wherein the protective tube is mechanically coupled to the conductor tubing proximate to the first end.

13. The pressure sensor system recited in claim 9 above, wherein the pressure sensor system further comprises:
a protective tube for protecting the pressure sensor and support bladder and; and
a second end of the tube body, wherein the isolation tube is mechanically coupled to the support mandrel proximate to the second end.

14. The pressure sensor system recited in claim 1 above, wherein the pressure fitting further comprises one of a barbed fitting, a threaded fitting and a spiral barb.

15. The pressure sensor system recited in claim 1 above, wherein the pressure bladder is cylindrically shaped.

16. The pressure sensor system recited in claim 2 above, wherein the support mandrel is cylindrically shaped.
